(19) United States
(12) Patent Application Publication
(10) Pub. No.: US 2006/0045685 A1
(43) Pub. Date: Mar. 2, 2006

(54) Selectively movable motorcycle stand

(76) Inventors: Patrick A. Warner, Boulder, CO (US); Andrew P. Lull, Boulder, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/144,424

(22) Filed: Jun. 2, 2005

Related U.S. Application Data
(60) Provisional application No. 60/576,792, filed on Jun. 2, 2004.
(60) Provisional application No. 60/674,794, filed on Apr. 25, 2005.

(51) Int. Cl. B60P 3/00

(52) U.S. Cl. 414/458

(57) ABSTRACT

The present invention provides various embodiments of stands and lift bases capable of supporting various objects above a support surface. The stands and lift bases are configurable between a stationary and mobile configurations. The stands may include a frame and a top adapted to support various objects, and the lift bases may include a base adapted support a stationary stand. Embodiments of the stands and lift bases include a lift device that can be operated to engage or disengage wheels or rollers with the support surface to place the stand or base in stationary and mobile configurations. When in the mobile configuration, the stand or lift base is rollingly supported on the wheels or rollers. Some embodiments of the stands and lift bases also include locking devices that allow the user to fix the stand or lift base in the mobile and/or stationary configurations.

### CROSS-REFERENCE TO RELATED APPLICATIONS

This application claims the benefit of U.S. Provisional Application No. 60/674,794, filed on Apr. 25, 2005 and U.S. Provisional Application No. 60/576,792, filed on Jun. 2, 2004, which are both hereby incorporated herein by reference.

### BACKGROUND OF THE INVENTION

a. Field of the Invention

Aspects of this invention relate to stands used to support various objects, such as motorcycles and other types of vehicles above a support surface, some more particular aspects involve stands and lift bases having wheels that can be selectively manipulated to engage the support surface to allow a user to move the stand along the support surface.

b. Background Art

Many currently available motorcycle stands provide a frame upon which a motorcycle can be placed to allow a user to safely perform maintenance and other types of work on the motorcycle. However, many of these motorcycle stands do not allow a user to easily move the stand from one location to another while supporting a motorcycle. As such, a user desiring to relocate a motorcycle and stand during maintenance is oftentimes required to remove the motorcycle from the stand and then move the stand and motorcycle separately to the desired location. This can be problematic, especially if the motorcycle has been partially disassembled during maintenance, such as having one or more wheels removed.

### BRIEF SUMMARY OF THE INVENTION

The present invention provides various embodiments of stands and lift bases capable of supporting various objects above a support surface, such as a floor or the ground. The stands and lift bases are configurable between a stationary configuration and a mobile configuration. The stands may include a frame and a top adapted to support various objects, and the lift bases may include a base adapted support a stationary stand. Embodiments of the stands and lift bases include a lift device that can be operated to engage or disengage wheels or rollers with the support surface to place the stand or base in stationary and mobile configurations. When in the mobile configuration, the stand or lift base is rollingly supported on the wheels or rollers. When placed in the stationary configuration, one or more wheels are disengaged with the support surface so that the stand or lift base cannot easily be moved along the support surface. Some embodiments of the stands and lift bases also include locking devices that allow the user to fix the stand or lift base in the mobile and/or stationary configurations. It is to be appreciated that the stands and lift bases may also be used to support various types of objects, such as motorcycles, all-terrain vehicles (ATV's), and other similar vehicles. Examples of all-terrain vehicles include four-wheeled all-terrain vehicles, three-wheelers, snowmobiles, dirt bikes, and other similar types of vehicles.

In one embodiment, a stand for supporting motorcycles and all-terrain vehicles above of a support surface includes: a frame including a base portion; a first member coupled with the frame, the first member selectively movable between a first position and a second position; a second member coupled with the frame; a third member coupling the first member with the second member so that the second member correspondingly moves with the first member; and at least one first wheel coupled with the first member; at least one second wheel coupled with the second member. When the first member is in the first position, the frame is rollingly supported by the at least one first wheel and the at least one second wheel, and when the first member is in the second position, the frame is supported by the base portion.

In another embodiment, a stand for supporting motorcycles and all-terrain vehicles above of a support surface includes: a frame including a base portion; a first axle pivotally coupled with the frame; a second axle pivotally coupled with the frame; a first member connected with the first axle; a second member connected with the second axle; a third member coupling the first member with the second member; at least one first wheel connected with the first axle; and at least one second wheel connected with the second axle. When the first member moves to a first position, the at least one first wheel and the at least one second wheel engage the support surface to rolling support the frame; and when the first member moves to a second position, the frame is supported by the base portion.

In yet another embodiment, a stand for supporting motorcycles and all-terrain vehicles above of a support surface includes: a frame; a first member coupled with the frame, the first member selectively movable between a first position and a second position; at least one first wheel rotatably connected with the first member; and at least one second wheel rotatably connected with the frame. When the first member is in the first position, the frame is rollingly supported by the at least one first wheel and the at least one second wheel, and when the first member is in the second position, the frame is supported by the at least one second wheel and the base portion.

In still another embodiment, a stand for supporting motorcycles and all-terrain vehicles above of a support surface includes: a frame including a base portion; a jack connected with the frame, the jack operable between an extended configuration and a retracted configuration; and at least two wheels connected with the jack. When the jack is in the extended configuration, the frame is rollingly supported by the at least two wheels, and wherein jack the jack is in the retracted configuration, the frame is supported by the base portion.

In still another embodiment, a stand for supporting motorcycles and all-terrain vehicles above of a support surface includes: a frame; at least two wheels connected with the jack; and a jack connected with the frame, the jack being operable between an extended configuration and a retracted configuration. When the jack is in the retracted configuration, the frame is rollingly supported by the at least two wheels; and when the jack is in the extended configuration, the frame is supported by the jack.

In still another embodiment, a lift base for supporting motorcycles and all-terrain vehicles above of a support surface includes: a base adapted to support a motorcycle and all-terrain vehicle stand; a first member coupled with the base, the first member selectively movable between a first position and a second position; a second member coupled with the base; a third member coupling the first member with the second member so that the second member correspondingly moves with the first member; at least one first wheel coupled with the first member; and at least one second wheel coupled with the second member. When the first member is in the first position, the base is rollingly supported by the at least one first wheel and the at least one second wheel.

In still another embodiment, a stand for supporting motorcycles and all-terrain vehicles includes: a frame including a base portion; a plurality of wheels coupled with the frame; and a lift means for moving at least one of the plurality of wheels. The lift means is operable between a first position wherein the frame is rolling supported by the plurality of wheels and a second position wherein the frame is supported by the base portion.

In still another embodiment, a stand for supporting motorcycles and all-terrain vehicles including: a frame including a base portion; a first member coupled with the frame, the first member selectively movable between a first position and a second position; a second member coupled with the frame and with the first member; at least one first wheel coupled with the first member; and at least one second wheel coupled with the second member. When the first member is in the first position, the frame is rollingly supported by the at least one first wheel and the at least one second wheel, and when the first member is in the second position, the frame is supported by the base portion.

The features, utilities, and advantages of various embodiments of the invention will be apparent from the following more particular description of embodiments of the invention as illustrated in the accompanying drawings and defined in the appended claims.

### BRIEF DESCRIPTION OF THE DRAWINGS

FIG. 1 is an isometric view of one embodiment of a stand supporting a motorcycle thereon.

FIG. 2A is a right side view of the stand shown in FIG. 1 in a stationary configuration.

FIG. 2B is a front side view of the stand shown in FIG. 1 in a stationary configuration.

FIG. 2C is a cross-sectional view of the stand depicted in FIG. 2B, taken along line 2C-2C.

FIG. 3A is a right side view of the stand shown in FIG. 1 in a mobile configuration.

FIG. 3B is a front side view of the stand shown in FIG. 1 in a mobile configuration.

FIG. 3C is a cross-sectional view of the stand depicted in FIG. 3B, taken along line 3C-3C.

FIG. 4A is a detailed isometric view of the stand shown in FIG. 1 in a stationary configuration.

FIG. 4AA is a front side view of the stand shown in FIG. 4A.

FIG. 4B is a right side view of the stand shown in FIG. 4A.

FIG. 4C is a cross-sectional view of the stand depicted in FIG. 4B, taken along line 4C-4C.

FIG. 4D is a cross-sectional view of the stand depicted in FIG. 4B, taken along line 4D-4D.

FIG. 4E is a cross-sectional view of the stand depicted in FIG. 4D, taken along line 4E-4E.

FIG. 5A is a detailed isometric view of the stand shown in FIG. 1 in a mobile configuration.

FIG. 5B is a right side view of the stand shown in FIG. 5A.

FIG. 5C is a cross-sectional view of the stand depicted in FIG. 5B, taken along line 5C-5C.

FIG. 5D is a cross-sectional view of the stand depicted in FIG. 5B, taken along line 5D-5D.

FIG. 5E is a cross-sectional view of the stand depicted in FIG. 5D, taken along line 5E-5E.

FIG. 6A is a top view of the stand shown in FIG. 1.

FIG. 6B is a cross-sectional view of the stand depicted in FIG. 6A, taken along line 6B-6B.

FIG. 6C is an alternative embodiment of a caster wheel with a brush.

FIG. 7A shows a stand with a tie-down securing a motorcycle on the stand.

FIG. 7B is a detailed view of the tie-down and stand shown in FIG. 7A.

FIG. 8A shows a stand with hooks.

FIG. 8B is a cross-sectional view of the stand depicted in FIG. 8A, taken along line 8B-8B.

FIG. 9A shows a stand with a top drain and a removable tool tray.

FIG. 9B shows an alternative embodiment of a stand top.

FIG. 10A is a cross sectional view of a first alternative embodiment of a stand in a stationary configuration.

FIG. 10B shows the stand in FIG. 10A in a mobile configuration.

FIG. 11A is a cross sectional view of a second alternative embodiment of a stand in a stationary configuration.

FIG. 11B shows the stand in FIG. 11A in a mobile configuration.

FIG. 11C is a cross-sectional view of the stand depicted in FIG. 11A, taken along line 11C-11C.

FIGS. 11D-11F show an alternative embodiment of a locking device.

FIG. 12A is a cross sectional view of a third alternative embodiment of a stand in a stationary configuration.

FIG. 12B shows the stand in FIG. 12A in a mobile configuration.

FIG. 13A is a cross sectional view of a fourth alternative embodiment of a stand in a stationary configuration.

FIG. 13B shows the stand in FIG. 13A in a mobile configuration.

FIG. 14A is a cross sectional view of a fifth alternative embodiment of a stand in a stationary configuration.

FIG. 14B shows the stand in FIG. 14A in a mobile configuration.

FIGS. 15A-15B show an alternative embodiment of a selectively positionable wheel coupled with a stand frame.

FIG. 16A is a cross sectional view of a sixth alternative embodiment of a stand in a stationary configuration.

FIG. 16B shows the stand in FIG. 16A in a mobile configuration.

FIG. 17A is a cross sectional view of a seventh alternative embodiment of a stand in a stationary configuration.

FIG. 17B shows the stand in FIG. 17A in a mobile configuration.

FIG. 17C is a cross-sectional view of the stand depicted in FIG. 17B, taken along line 17C-17C.

FIG. 18 is schematic view of an eighth alternative embodiment of a stand.

FIG. 19A is schematic view of a stand with a collapsible frame.

FIG. 19B shows the stand frame in FIG. 19A in a partially folded configuration.

FIG. 20 is an isometric view of a lift base.

FIG. 21 is a first alternative embodiment of a lift base.

FIG. 22A is a second alternative embodiment of a lift base.

FIGS. 22B-22C are detailed views of a pivot member of the lift base shown in FIG. 22A.

### DETAILED DESCRIPTION OF THE INVENTION

Aspects of the present invention involve stands and lift bases capable of supporting various objects above a support surface, such as a floor or the ground. The stands and lift bases are configurable between a stationary configuration and a mobile configuration. As discussed below, the stands may include a frame and a top adapted to support various objects, and the lift bases may include a base adapted support a stationary stand. As such, a user can place the stationary stand on the lift base in locations where it is desirable to provide the benefits of a mobile stand. In addition, the stationary stand can be removed from the lift base and used in a location where it is desirable to utilize only the stationary stand. As discussed in more detail below, the stands and lift bases include a plurality of wheels or rollers. Embodiments of the stands and lift bases also include a lift device that can be operated by the user's hand or foot to engage or disengage wheels with the support surface to place the stand or base in stationary and mobile configurations. When in the mobile configuration, the stand or lift base is rollingly supported on the wheels or rollers, allowing a user to easily push or pull the stand or lift base (and any object supported thereon) along the support surface. When placed in the stationary configuration, one or more wheels are disengaged with the support surface so that the stand or lift base cannot easily be moved along the support surface. As discussed in more detail below, some embodiments of the stands and lift bases also include locking devices that allow the user to fix the stand or lift base in the mobile and/or stationary configurations. Although the stands and lift bases are described and depicted below as supporting a motorcycle, it is to be appreciated that the stands and lift bases may also be used to support various types of objects as well as motorcycles, such as all-terrain vehicles (ATV's) and other similar vehicles. Examples of all-terrain vehicles include four-wheeled all-terrain vehicles, three-wheelers, snowmobiles, dirt bikes, and other similar types of vehicles.

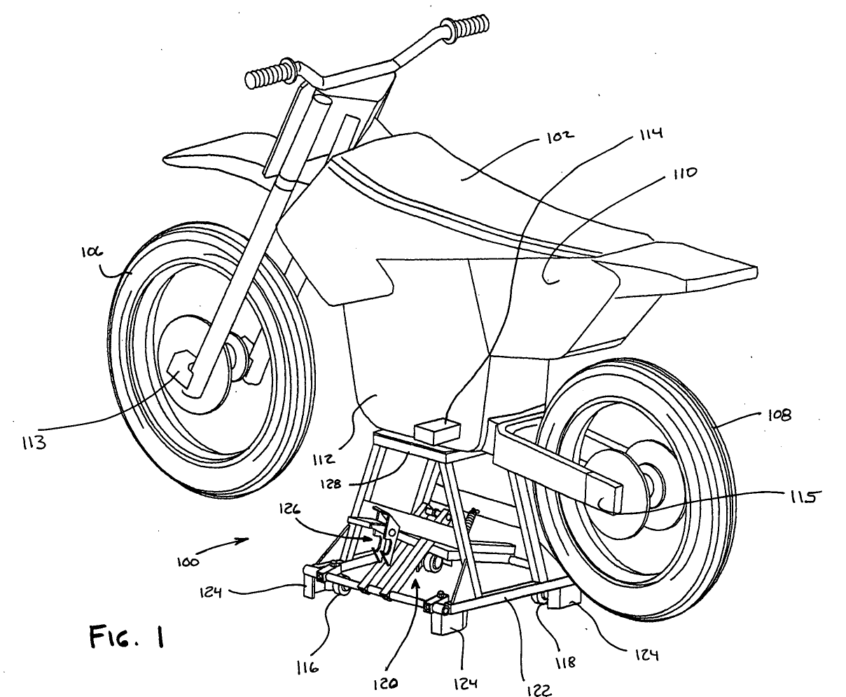

Various stand embodiments are shown in FIGS. 1-19B and various lift base embodiments are shown in FIGS. 20-22B. As previously mentioned, the stands and lift bases each include a frame and a plurality of wheels. In some embodiments, at least one wheel is coupled with the frame through a lift device that allows a user to selectively engage the at least one wheel with the support surface such that stand or base is rollingly supported by the plurality of wheels. In other embodiments, all wheels are coupled with the frame through the lift device, and as such, are all selectively positionable to engage or disengage the support surface. In yet other embodiments, all the wheels are rotatably connected with frame, and the lift device is used to raise and lower the stand to selectively engage or disengage the wheels with the support surface. Although the stands and lift bases described below are shown with four wheels, it is to be appreciated that the stands and lift bases can include more or less than four wheels. For example, some embodiments of the stands and lift bases include three wheels, while other embodiments utilize only two cylindrically-shaped rollers having sufficient lengths to stably support the stand or lift base.

FIGS. 1-3C show a stand 100 according to one embodiment of the present invention used to support a motorcycle 102 above a support surface 104, such as the ground or a floor. The motorcycle depicted includes front and rear wheels 106, 108, a motorcycle frame 110, and an engine compartment 112. It is to be appreciated that the motorcycle is shown for illustrative purposes only, and as such, the illustrated motorcycle 102 should not be construed to limit the scope of the present invention. As shown in FIGS. 1-3C, the motorcycle 102 is supported on the stand 100 by the motorcycle frame 110, specifically below the engine compartment 112, such that both wheels 106, 108 of the motorcycle do not touch the support surface. It is to be appreciated that although the stand is depicted as supporting the motorcycle from below the engine compartment, embodiments of the stand can support motorcycles from different locations, such as by foot pegs 114 extending from sides of the motorcycle. Although the motorcycle shown in FIGS. 1-3C is shown as being supported on the stand in a generally right to left orientation, it is to be appreciated that the motorcycle can be oriented in any number of different directions while being supported by the stand. Further, although the motorcycle is depicted herein as being supported on the stand with both wheels 106, 108 of the motorcycle suspended above the support surface, it need not be. For example, some stand embodiments can be configured to support the motorcycle by front or rear wheel axles 113, 115 such that an opposing motorcycle wheel remains in contact with the support surface.

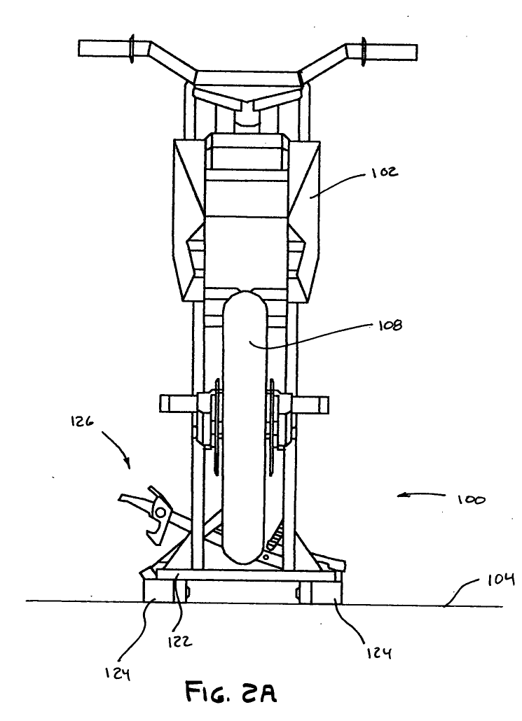

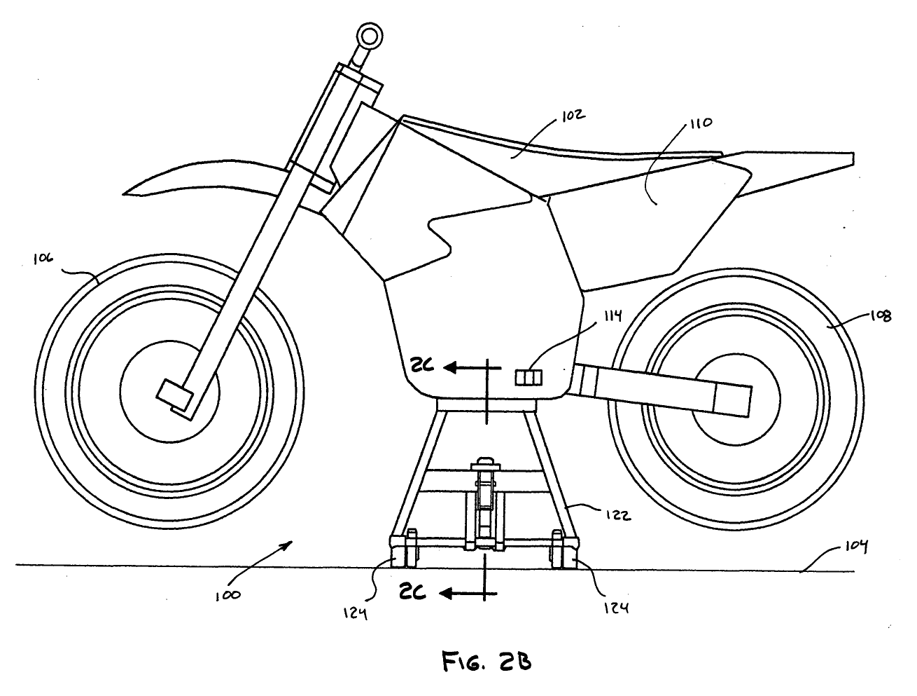

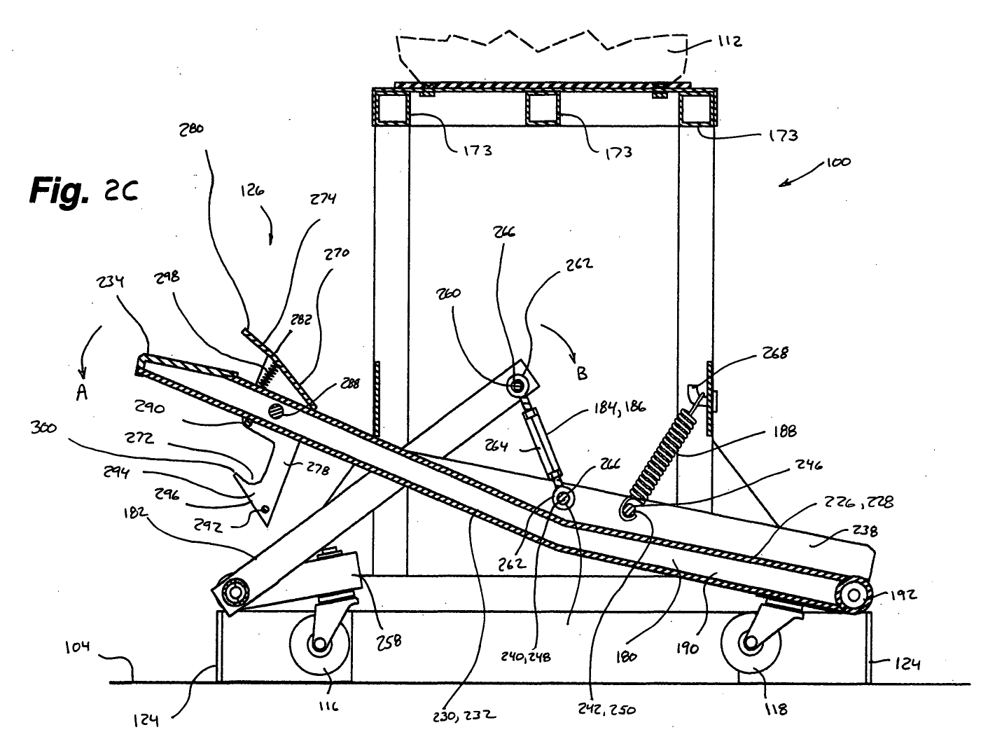

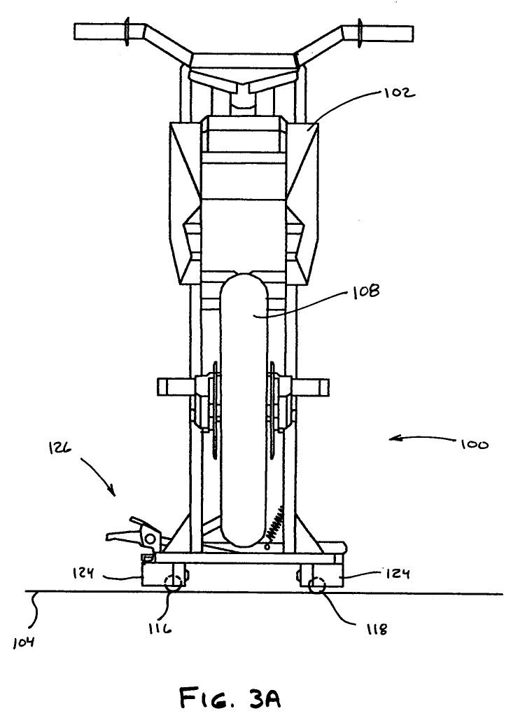

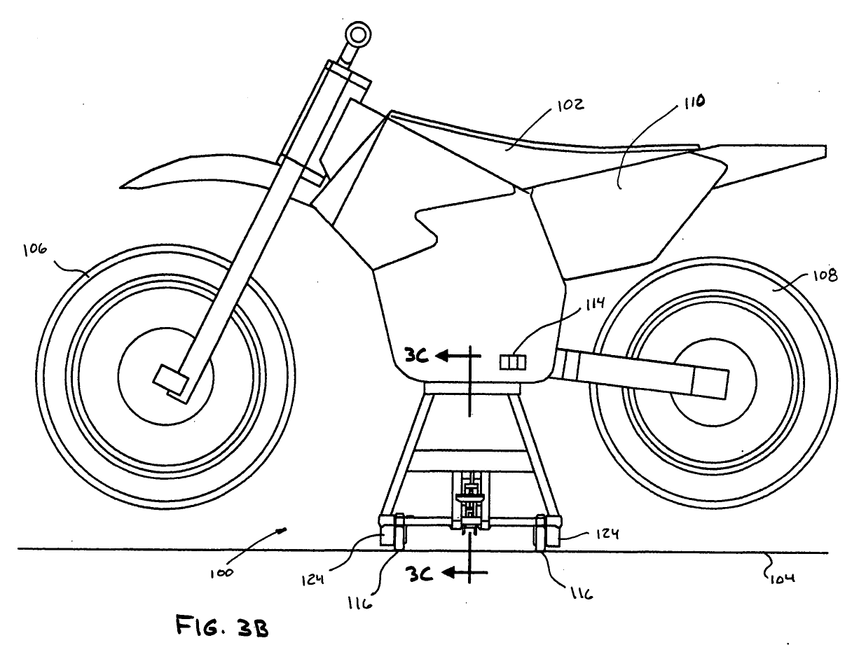

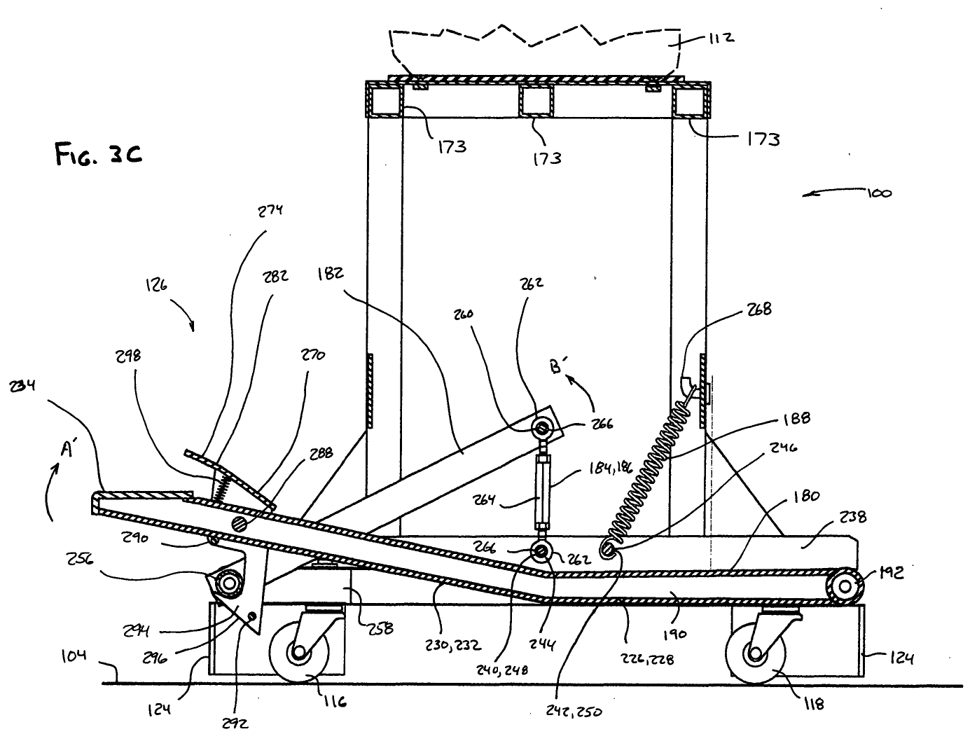

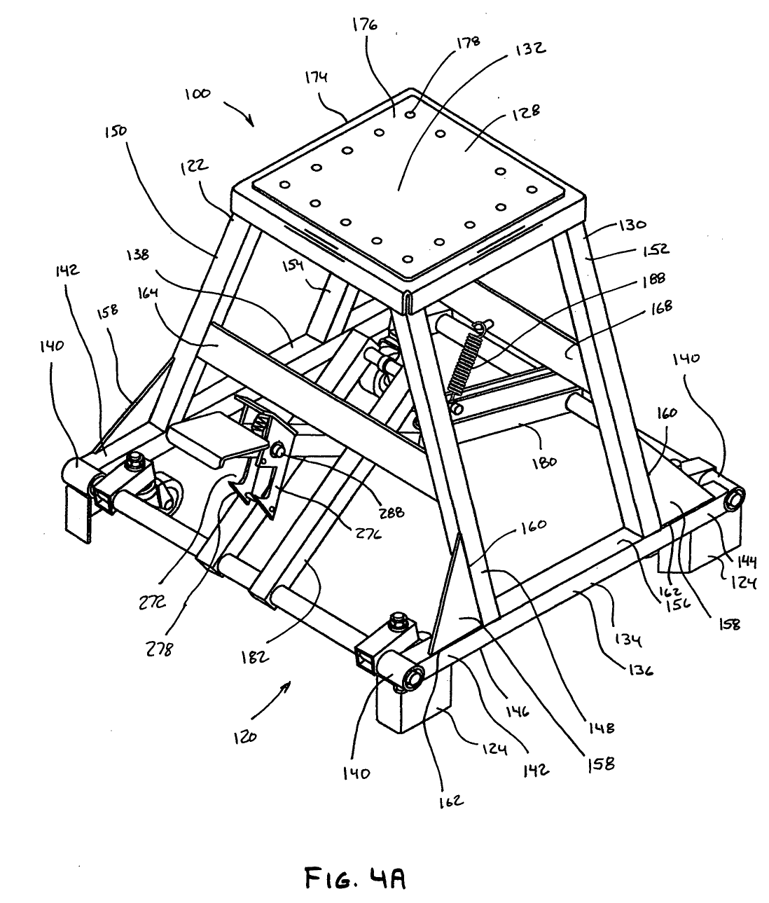

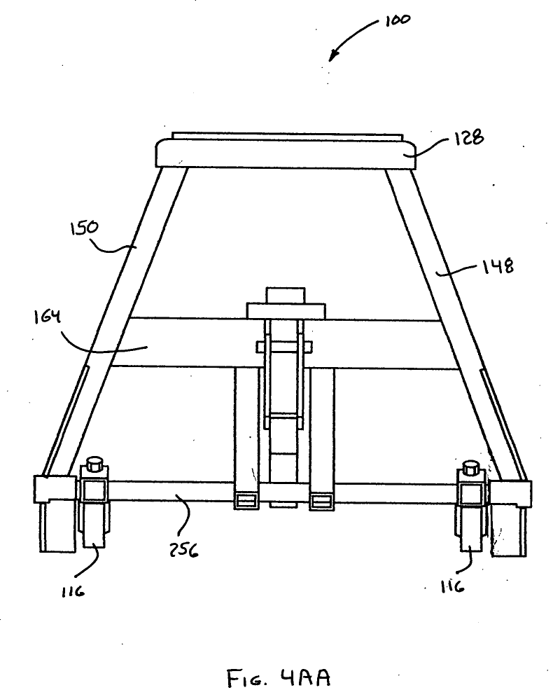

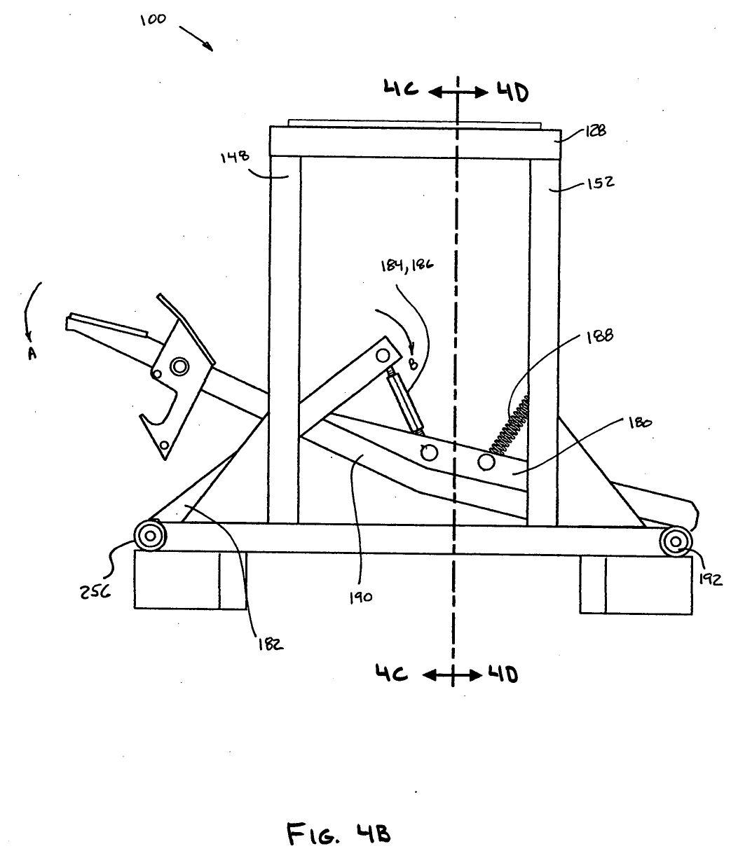

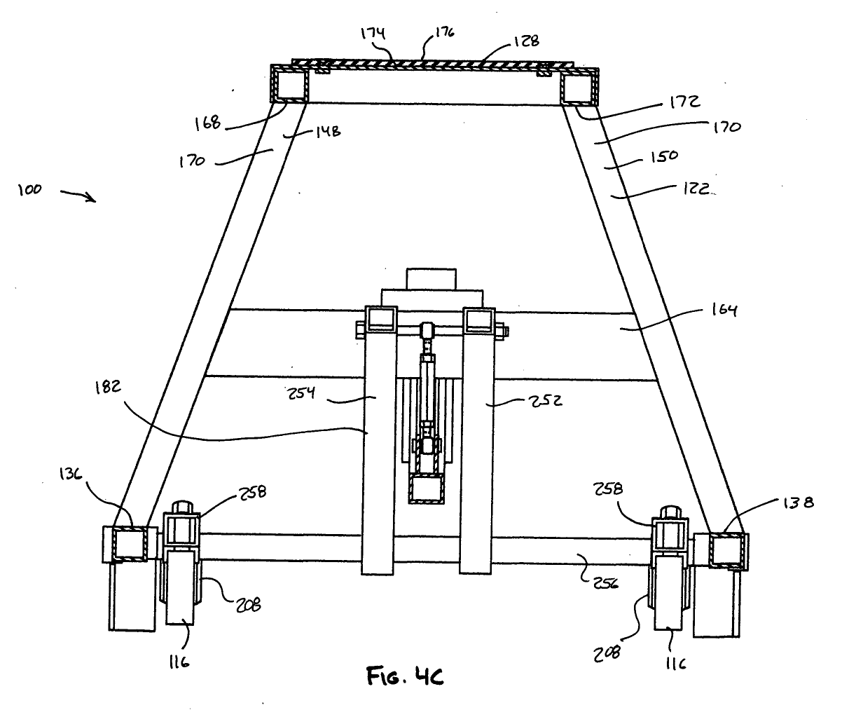

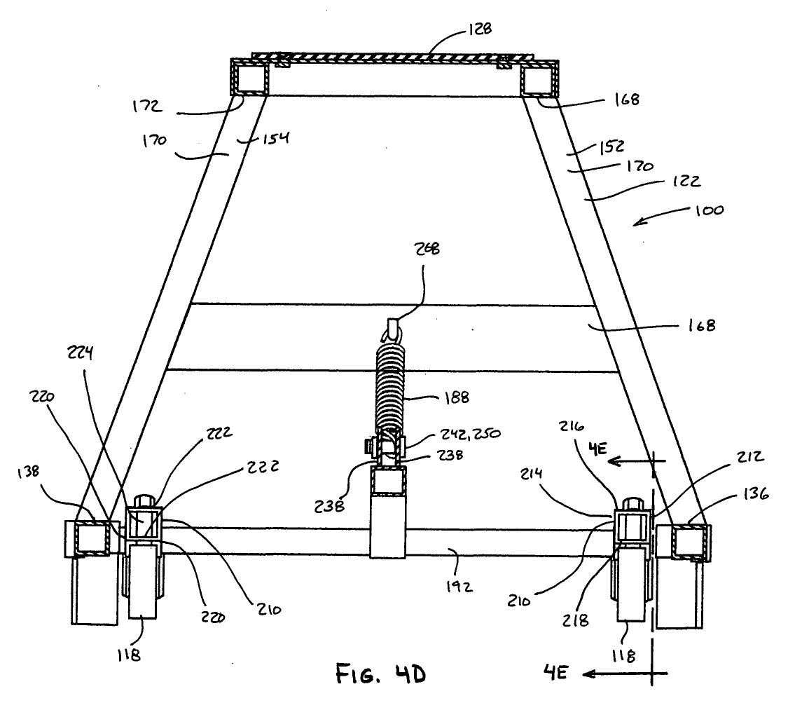

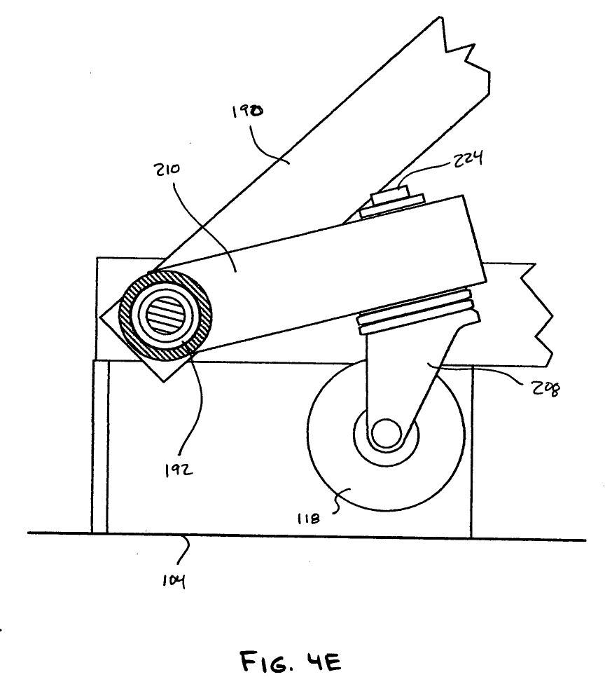

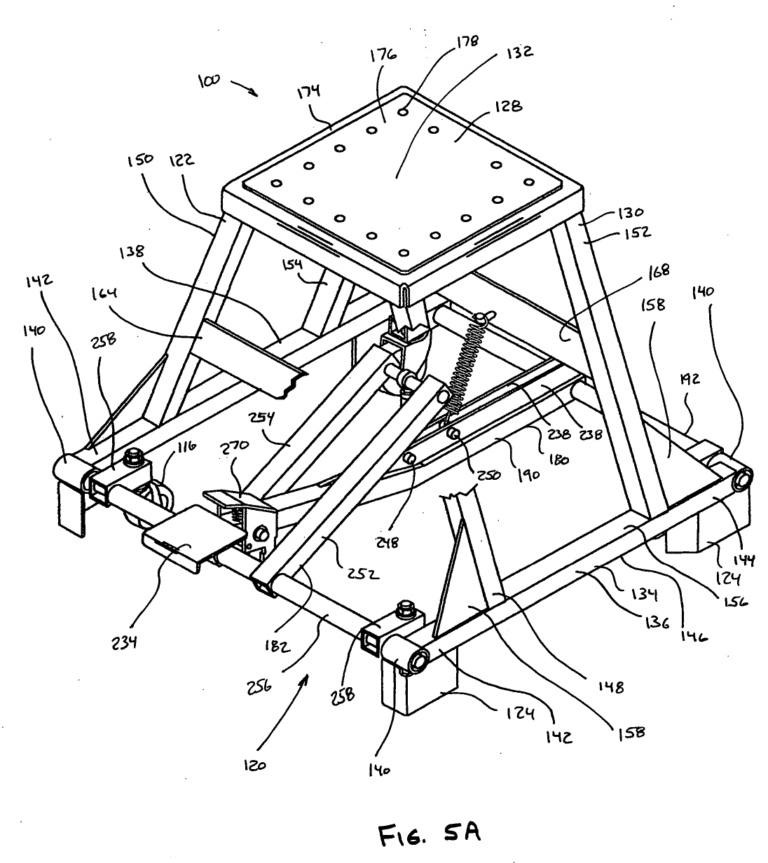

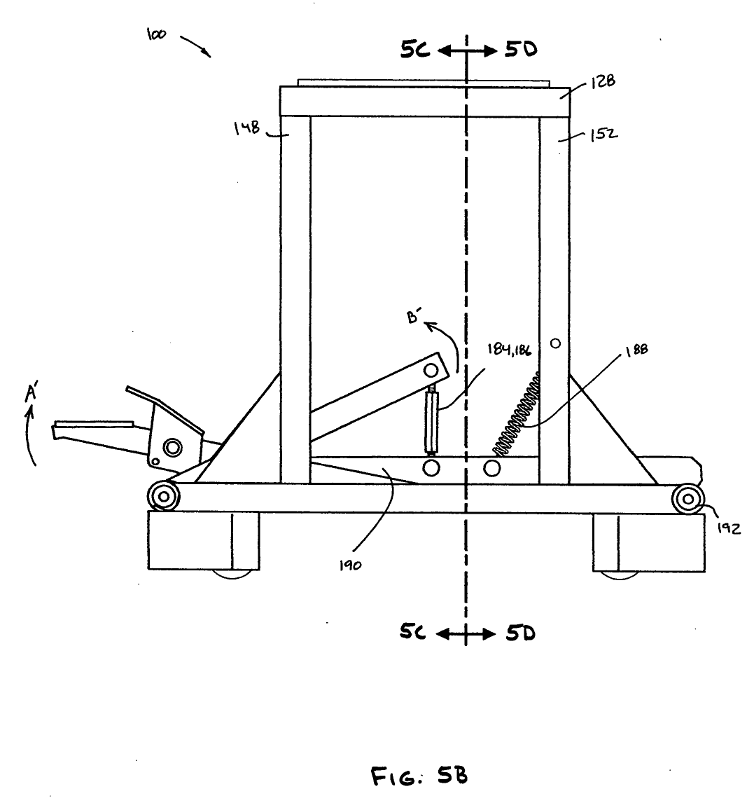

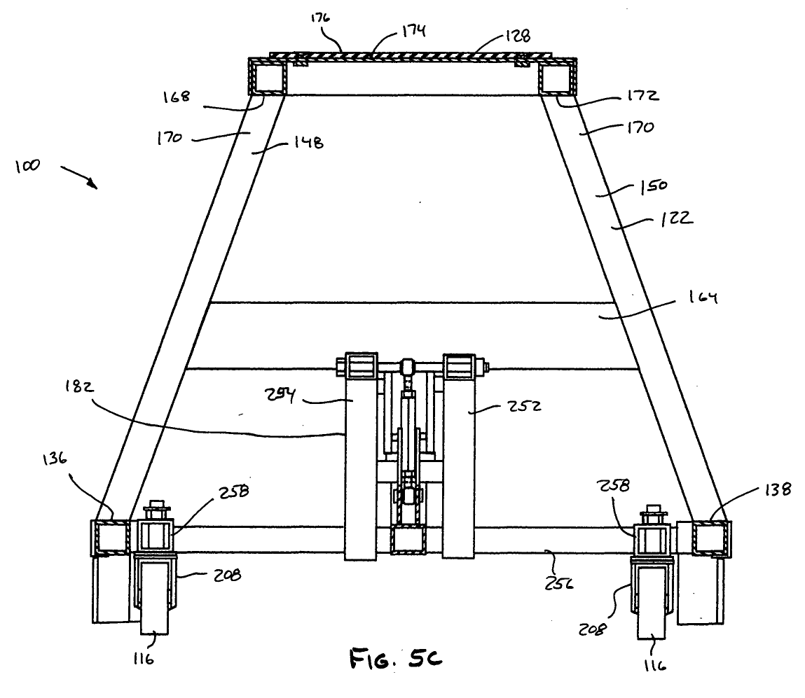

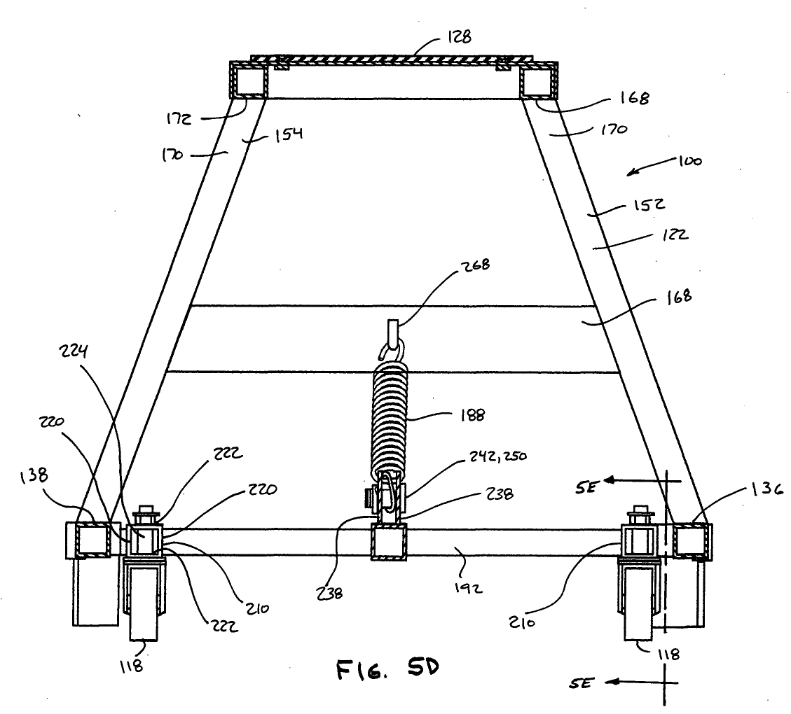

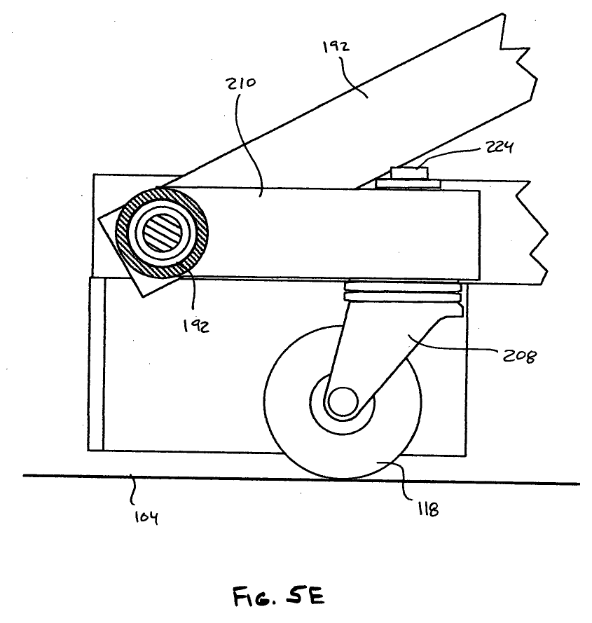

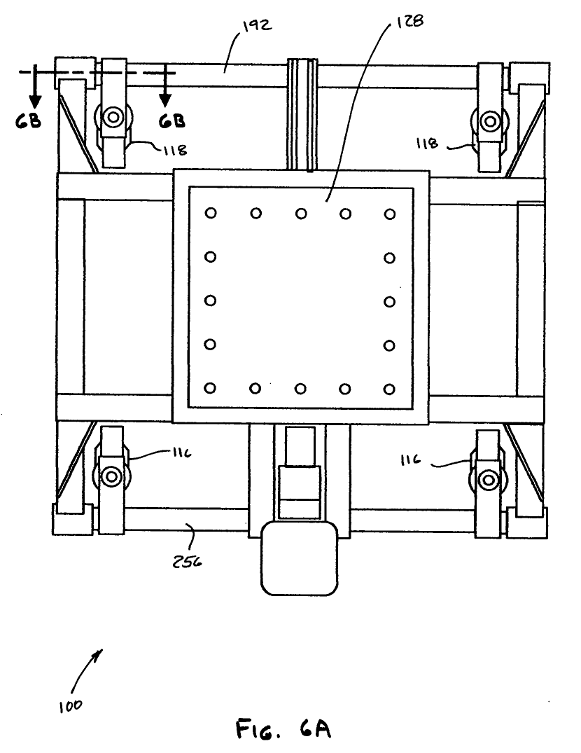

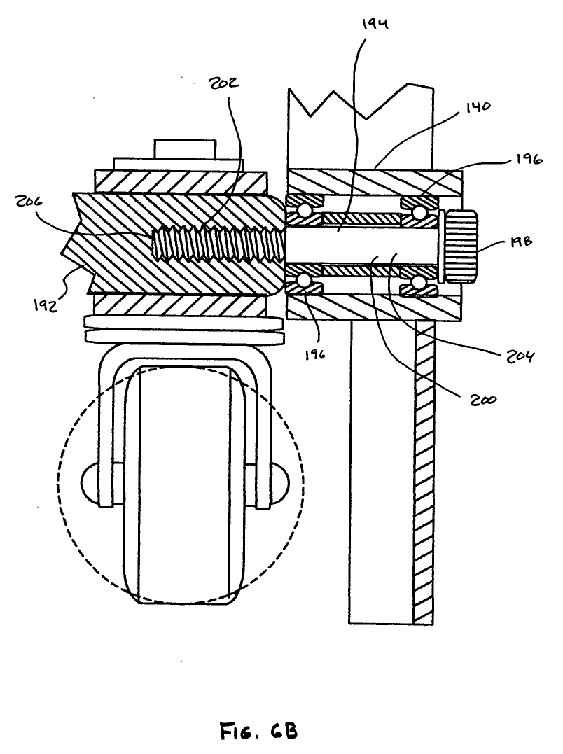

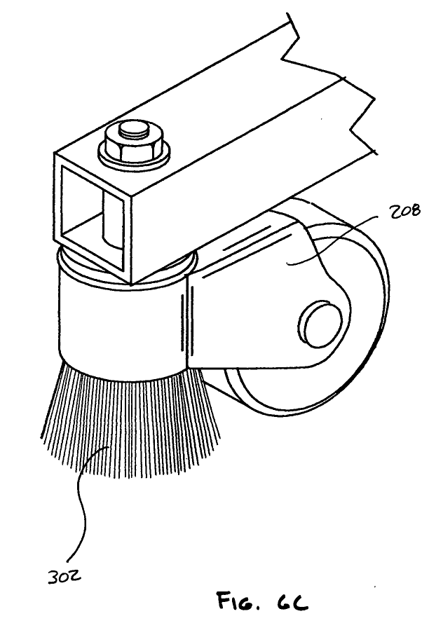

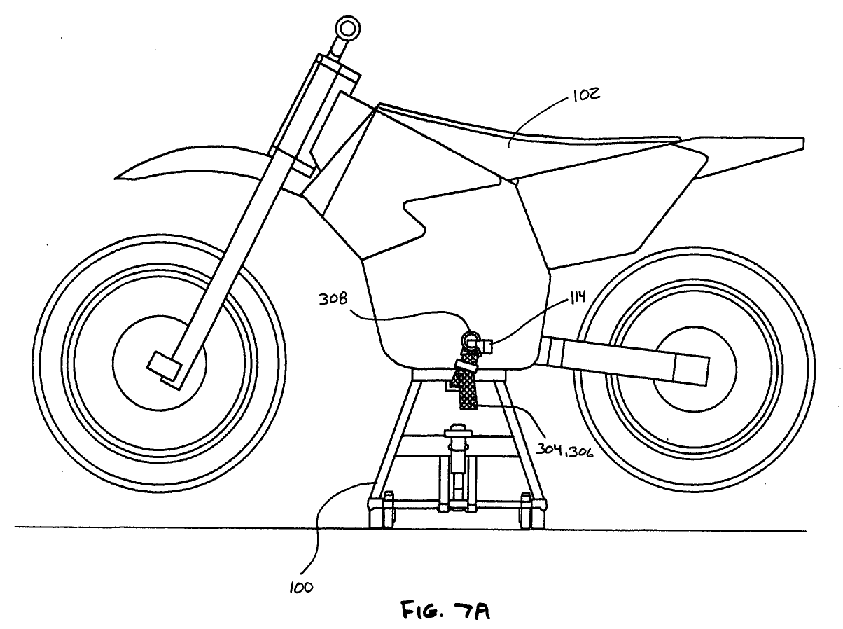

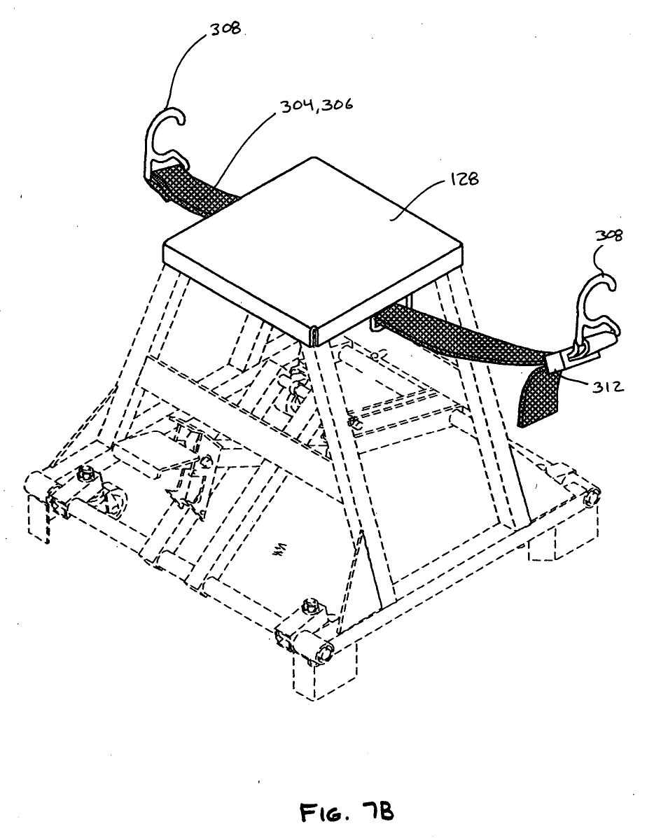

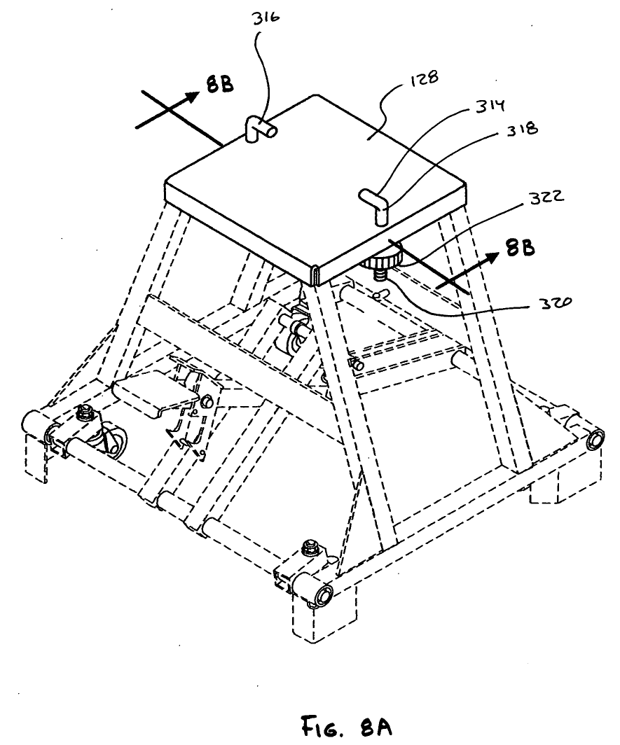

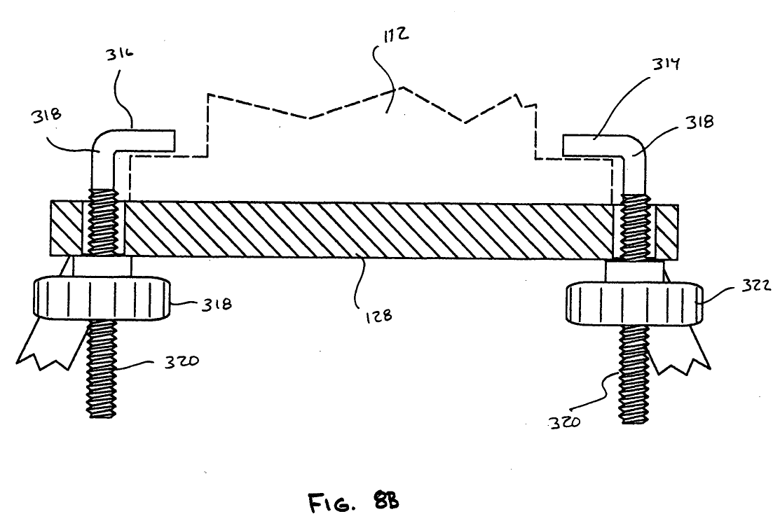

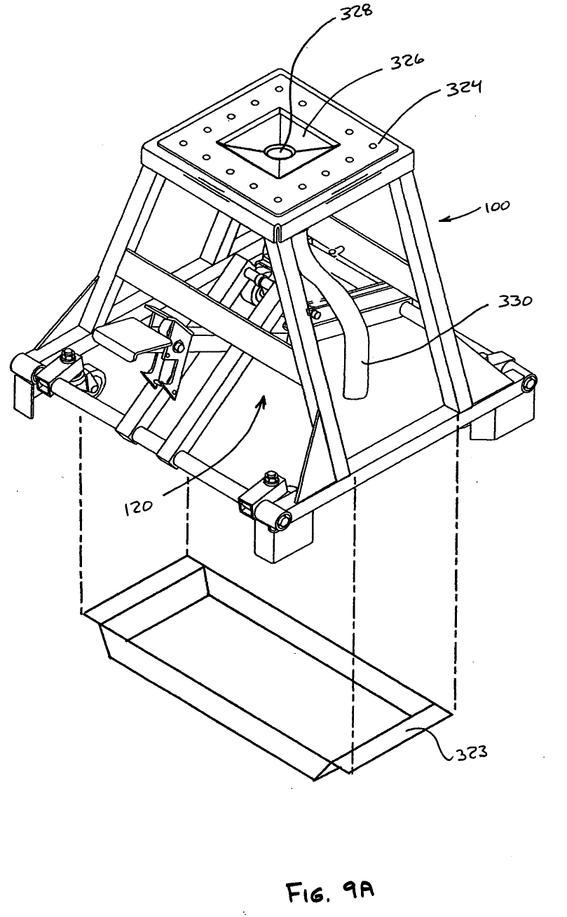

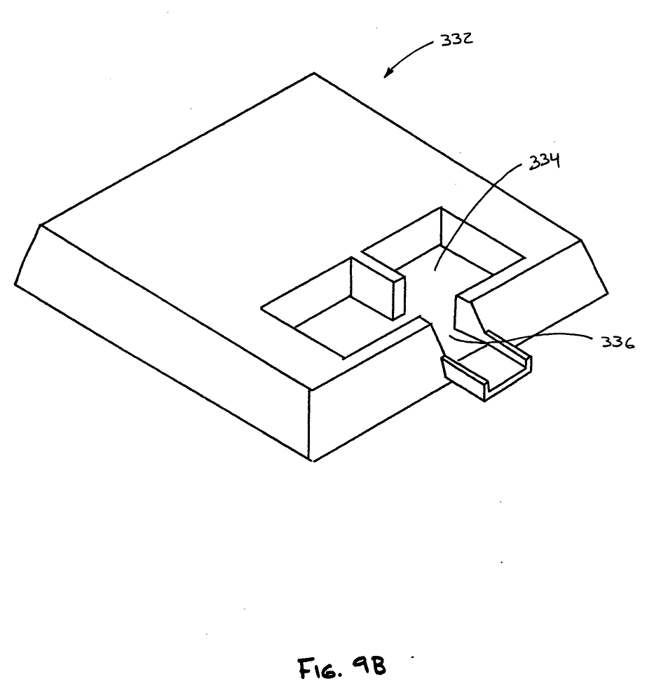

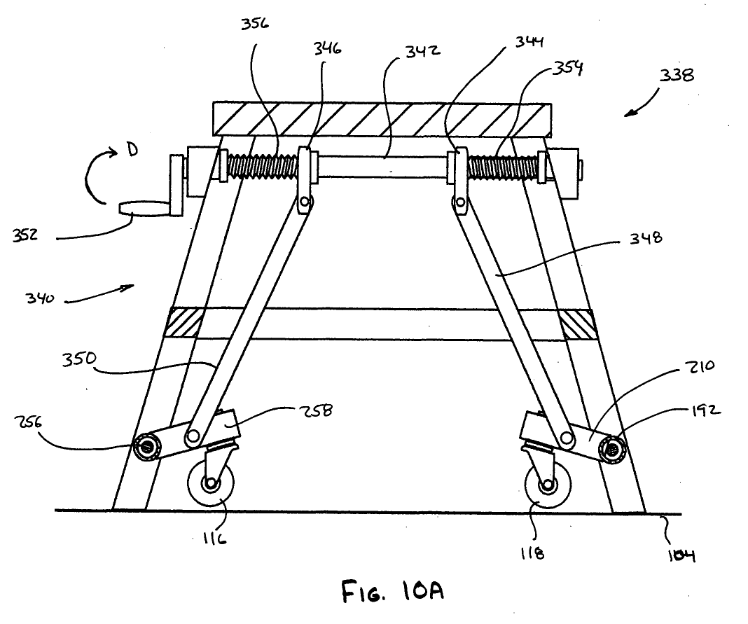

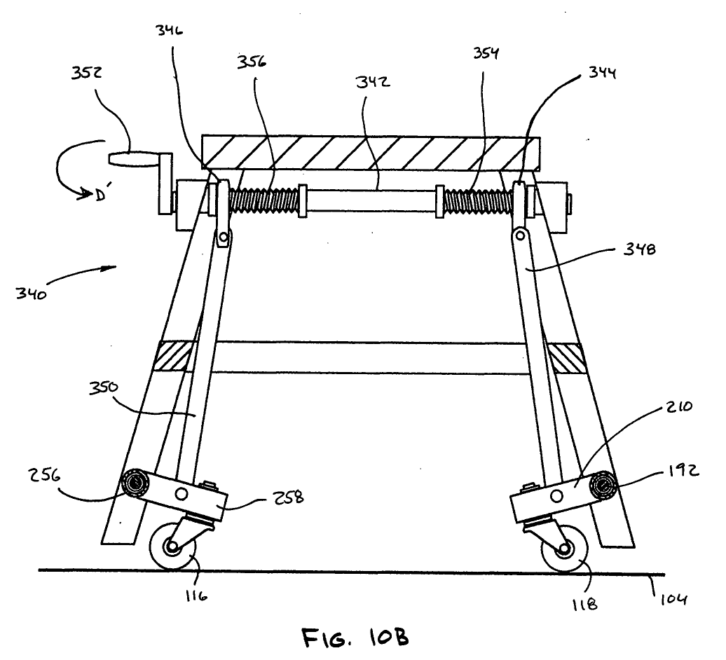

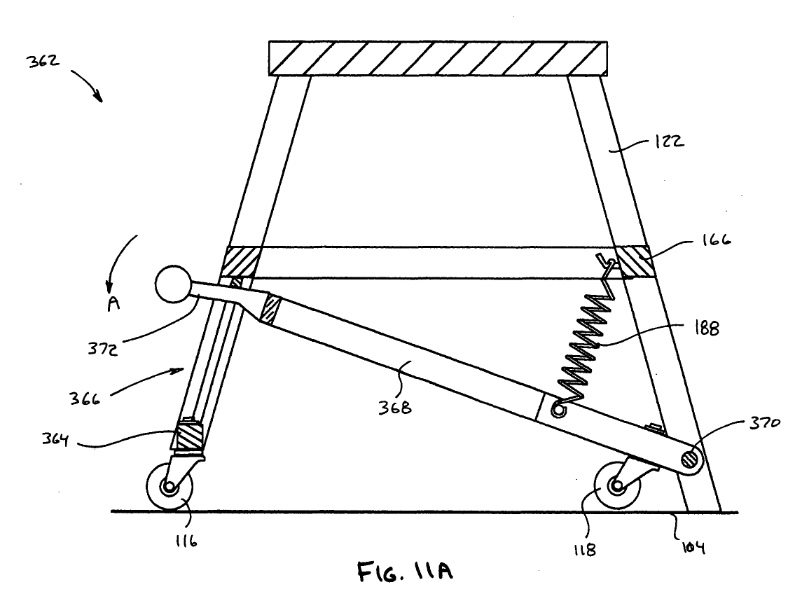

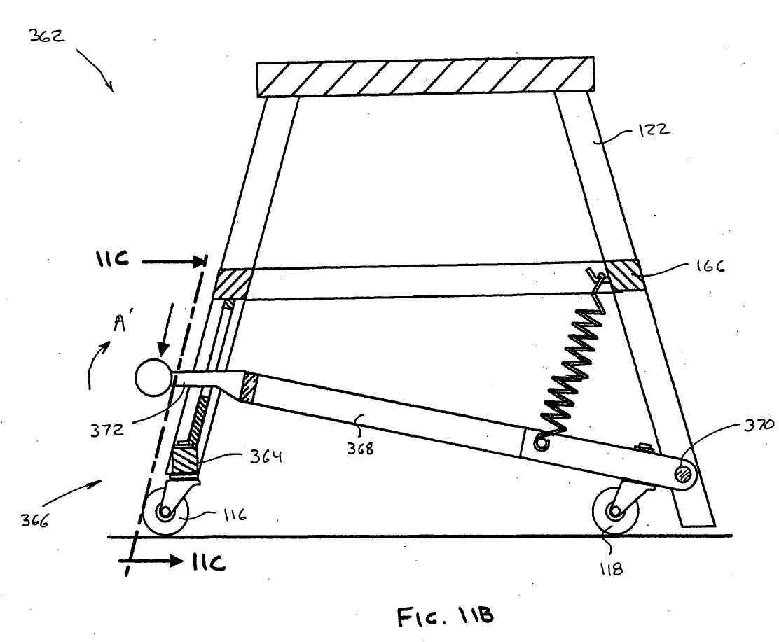

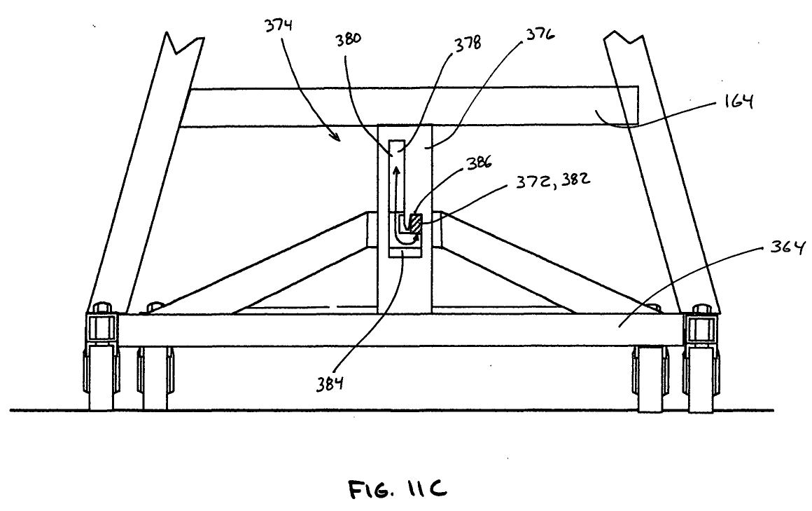

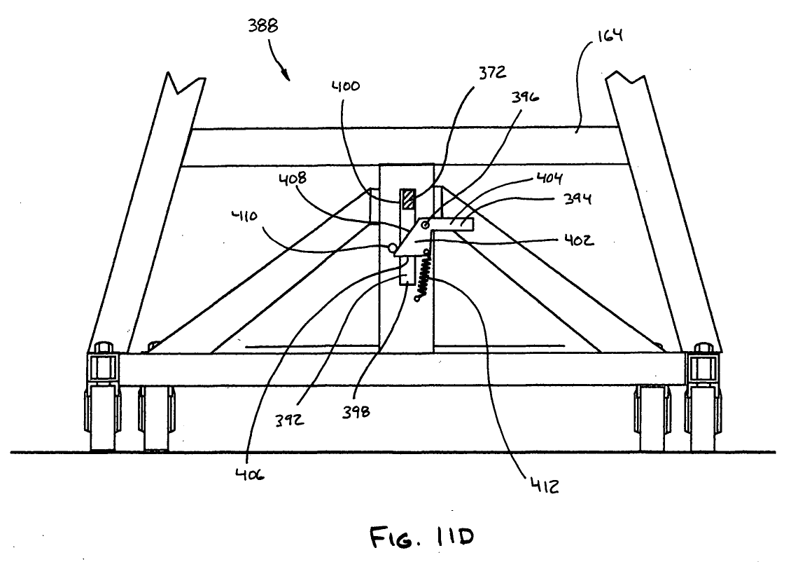

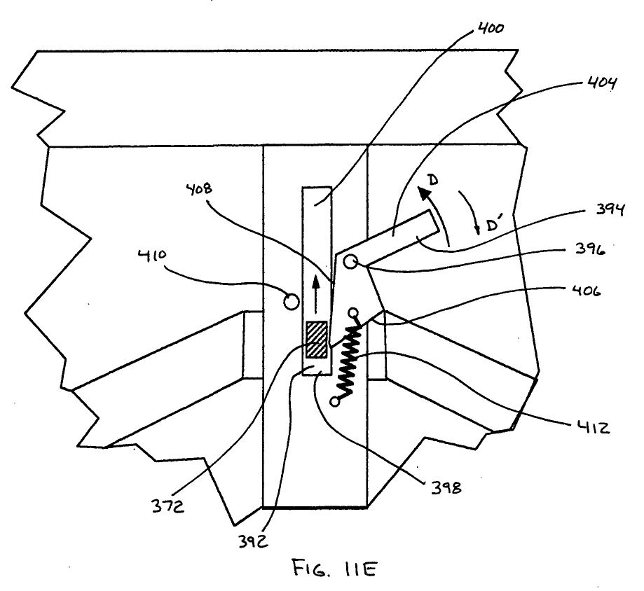

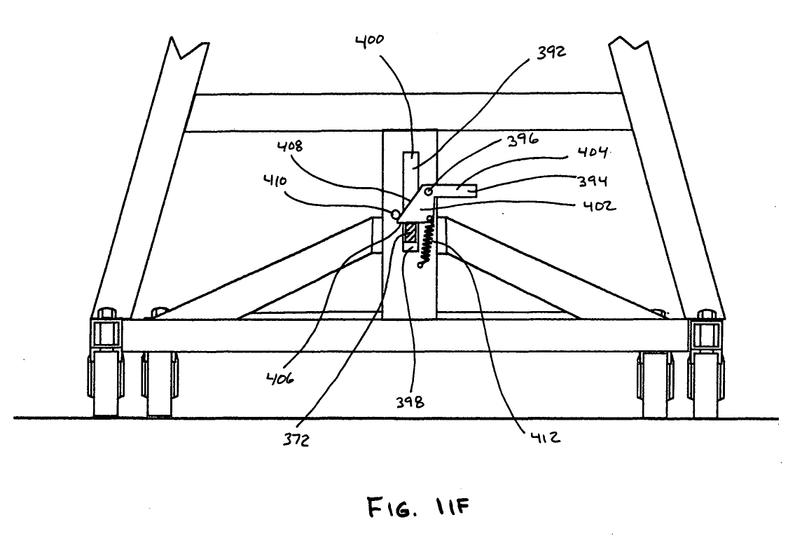

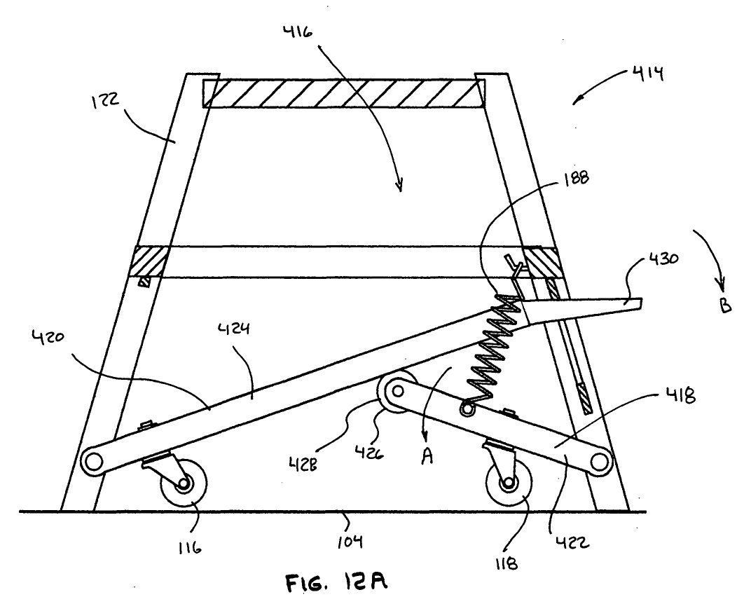

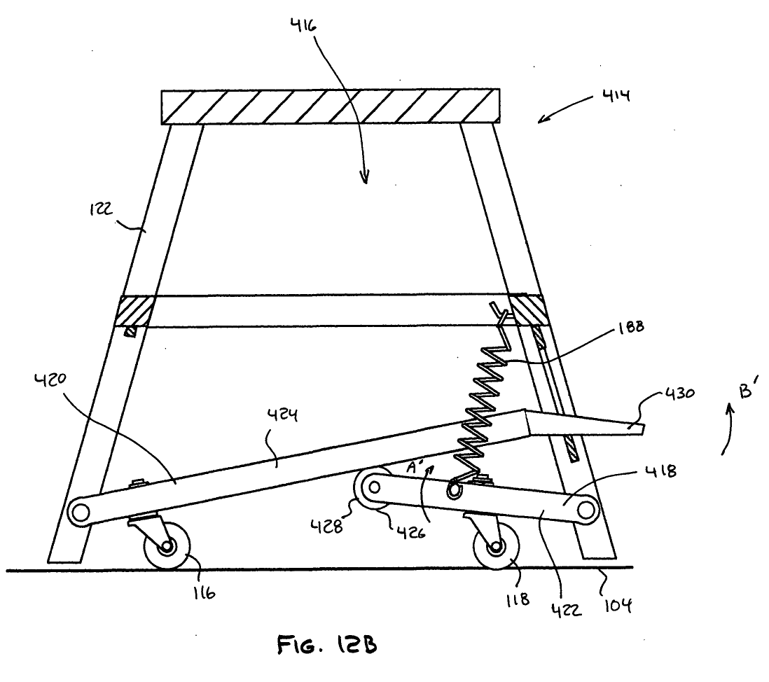

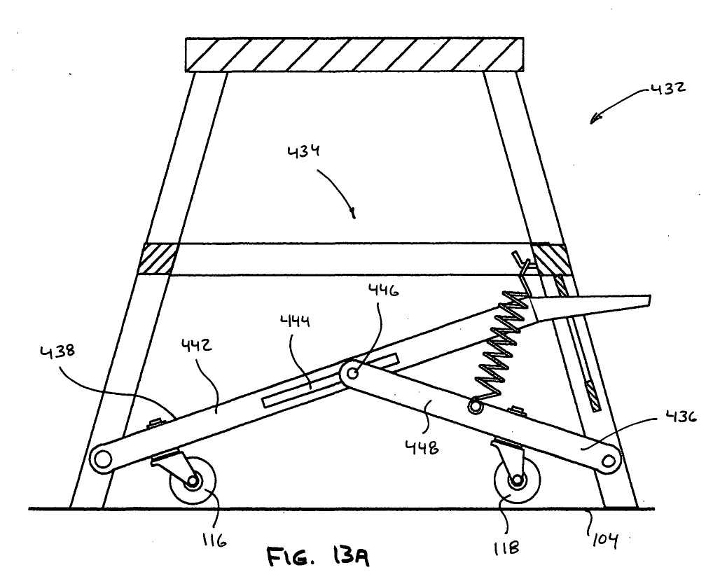

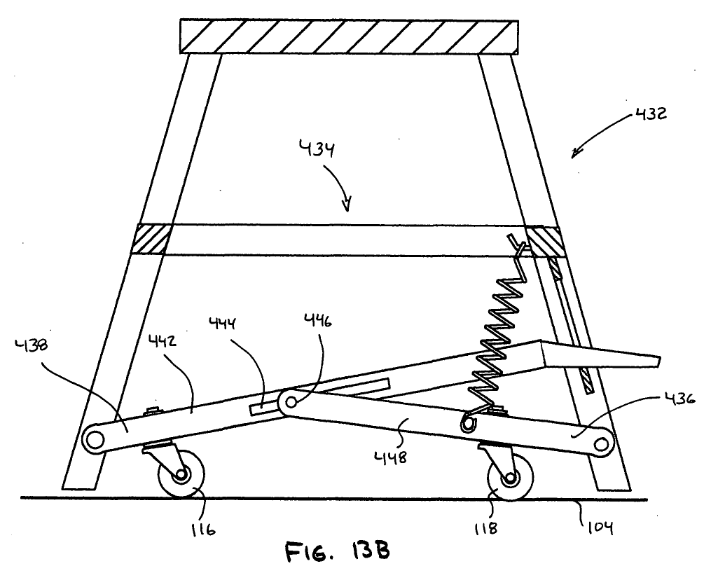

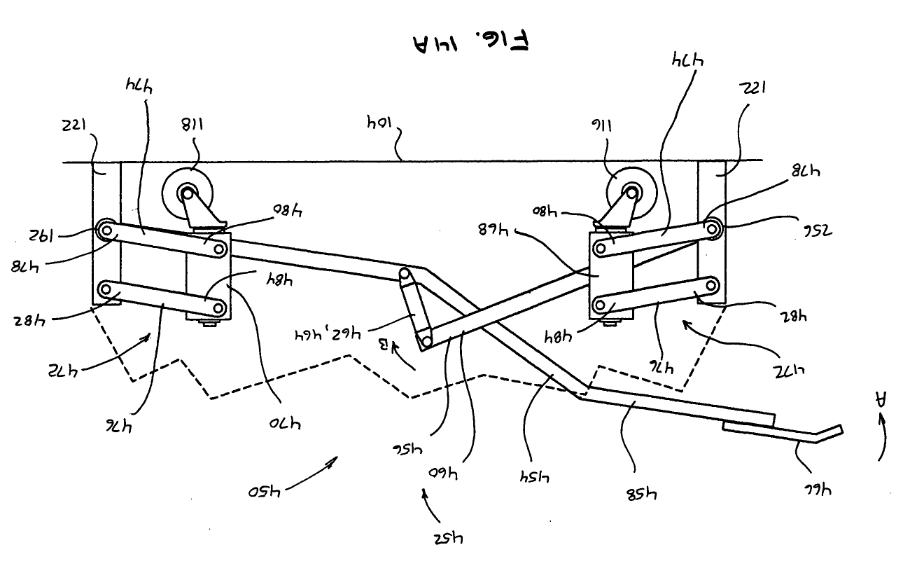

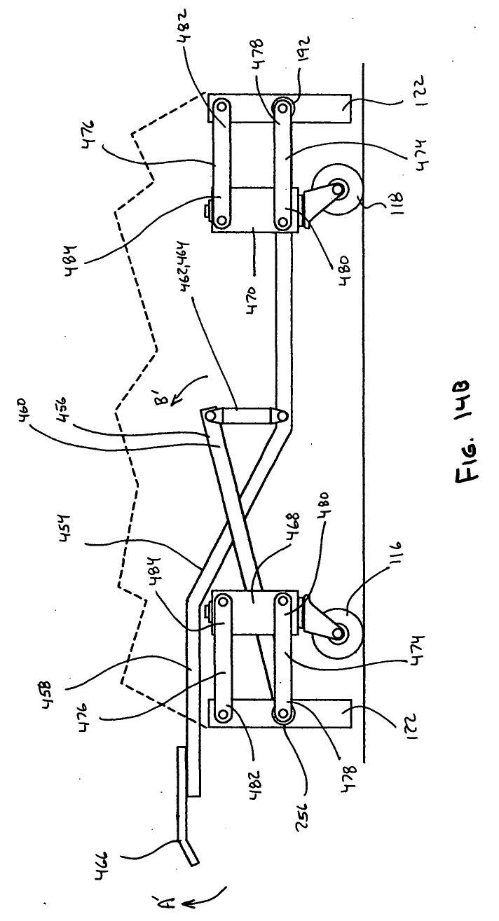

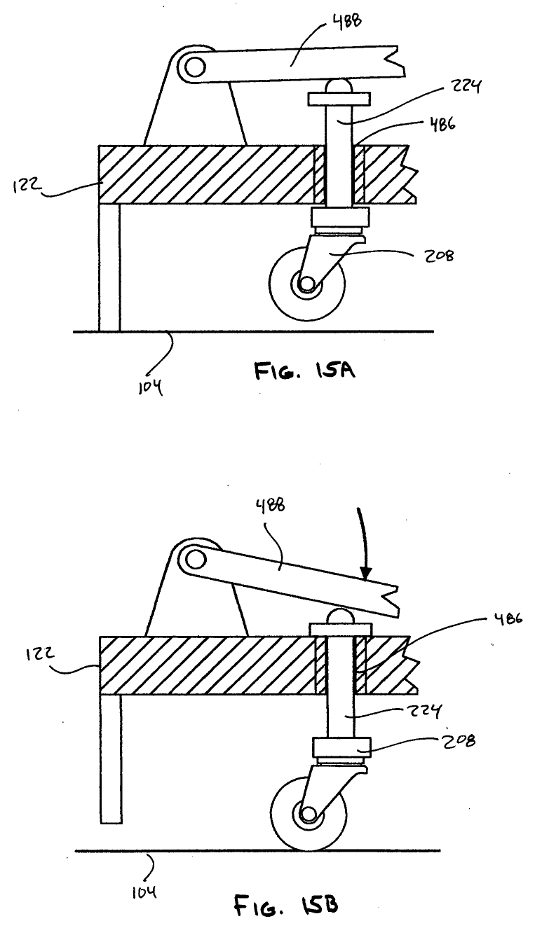

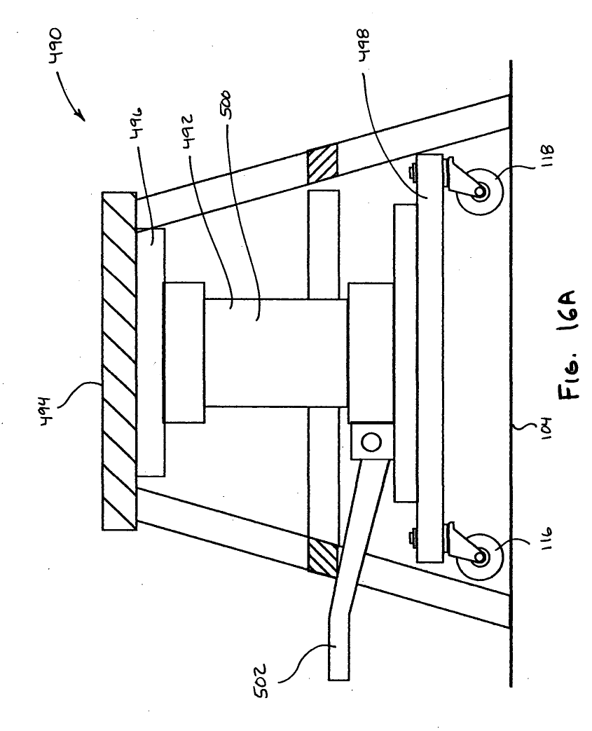

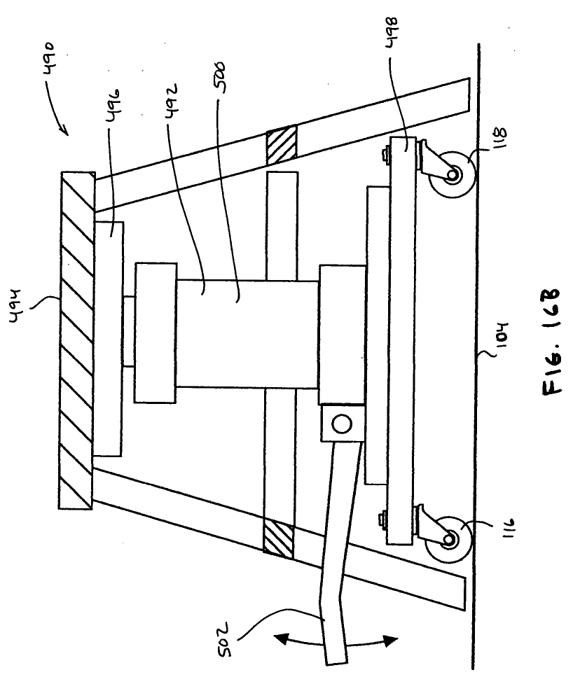

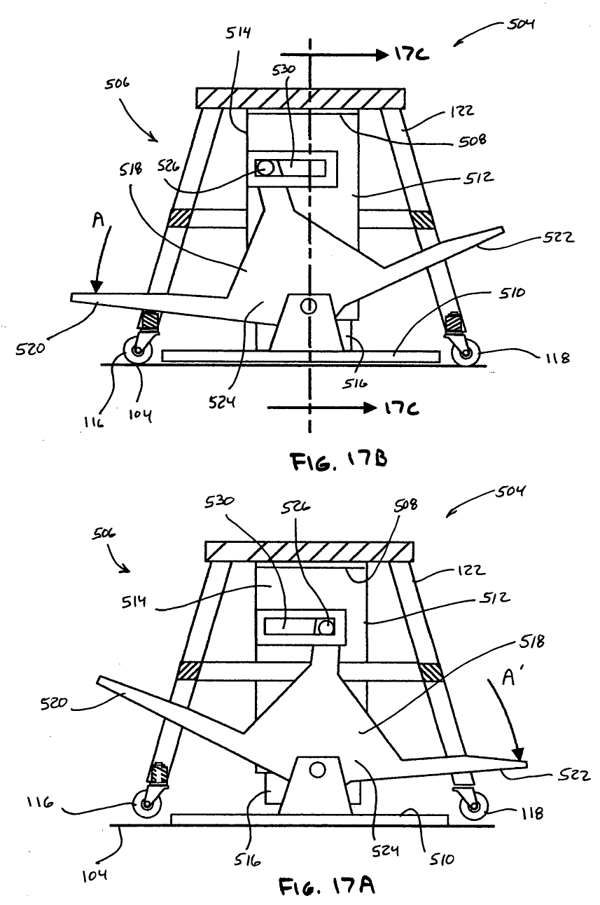

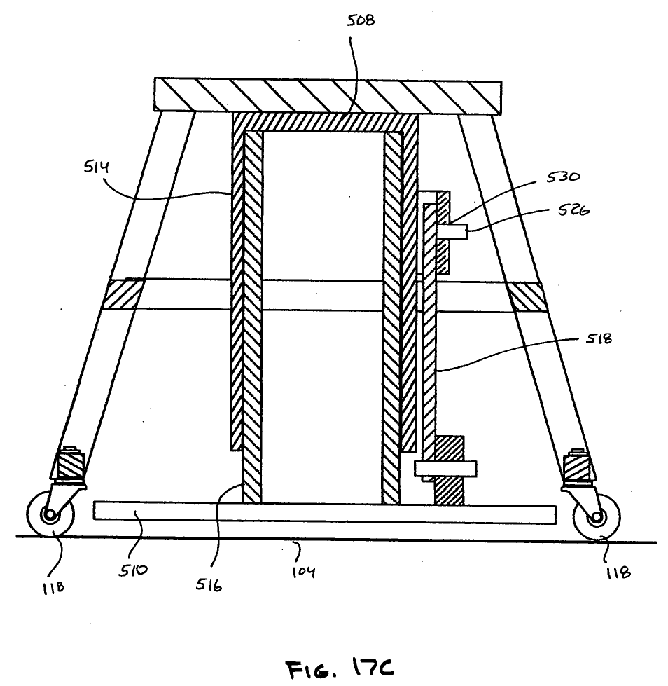

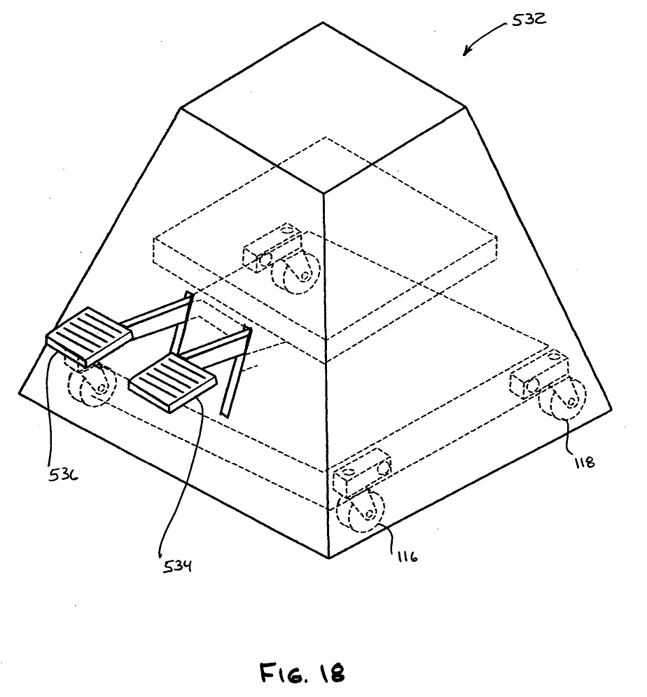

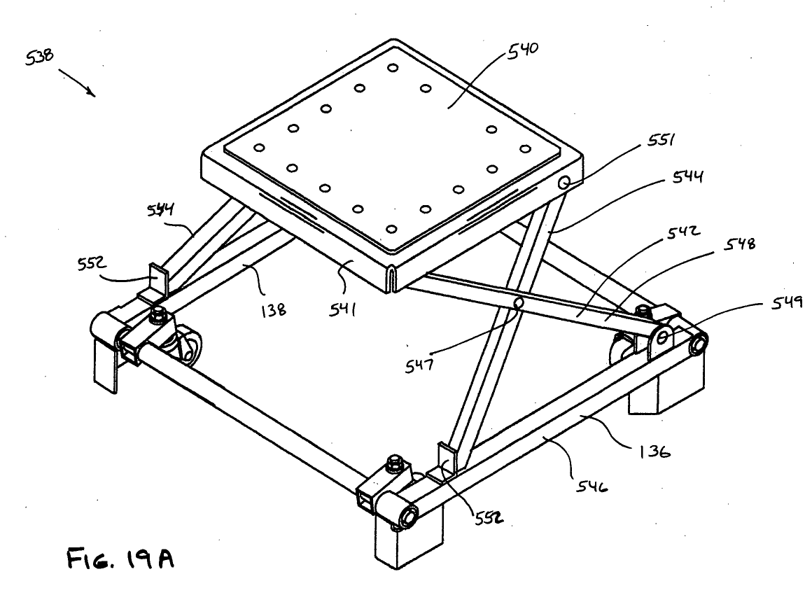

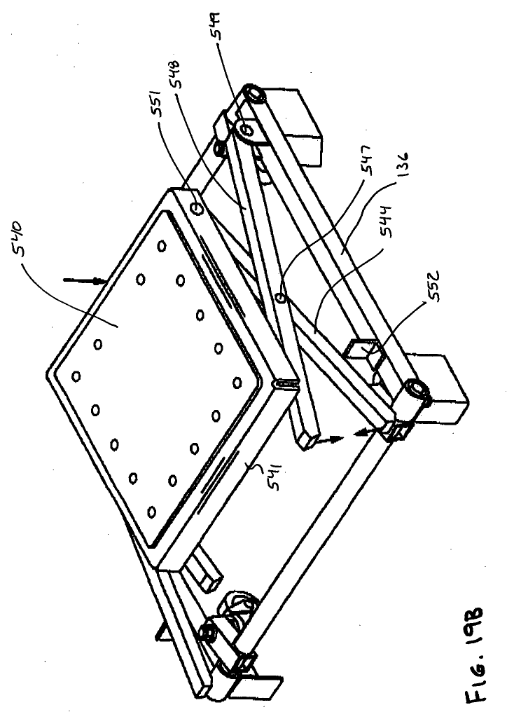

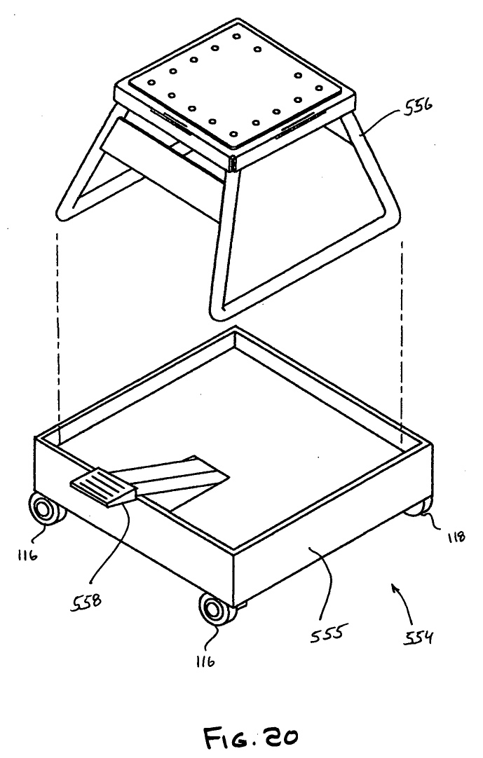

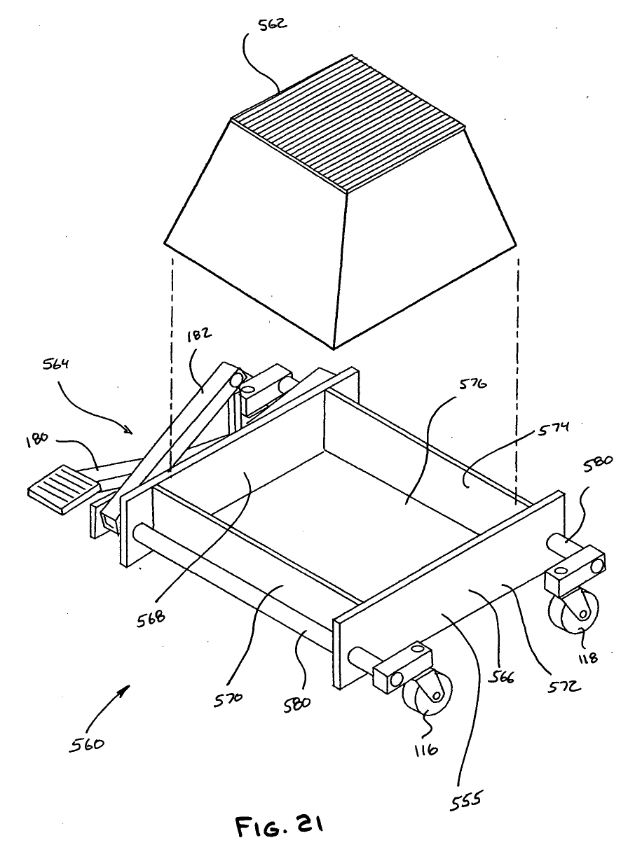

The stand shown in FIGS. 1-3C includes two front wheels 116 and two rear wheels 118 and a lift device 120 that allows a user to selectively engage the wheels with the support surface 104. As shown in FIGS. 2A-2C, when the stand 100 is in the stationary configuration, the wheels 116, 118 are positioned relative to the support surface so that the weight of the stand and object are supported by a frame 122. In the embodiment shown in FIGS. 2A-2C, the stand is supported by stationary feet 124 connected with and extending downward from the frame. Thus, the wheels are suspended above the support surface and/or may also be slightly touching the support surface. As discussed in more detail below, the user can operate the lift device 120 with his hand or foot so as to place the stand in the mobile configuration, as shown in FIGS. 3A-3C. As previously mentioned, the stand 100 may also include a locking device 126 that maintains the stand in the mobile and/or stationary configurations until the user operates the lift device 120 with his hand or foot. As shown in FIGS. 3A-3C, the lift device 120 is operated so as to place the stand in the mobile configuration. In the mobile configuration, the stand is supported on wheels that are engaged with the support surface. As such, a user can easily roll the stand 100 and the motorcycle 102 along the support surface between various locations. As discussed in more detail below, some embodiments of the stand are equipped with caster wheel assemblies that allow the user to easily change directions when pushing or pulling the stand while in the mobile configuration.

FIGS. 4A-6B show additional views of the first embodiment of the stand shown in FIGS. 1-3C. More particularly, FIGS. 4A-4E illustrate various views of the stand in the stationary configuration, and FIGS. 5A-5E illustrate various views of the stand in the mobile configuration. As shown in FIGS. 4A and 5A, the stand 100 includes a stand top 128 connected with an upper portion 130 of the frame 122. The stand top 128 provides an area 132 upon which an object that is to be supported can be placed, such as a motorcycle. The upper portion 130 of the frame 122 is supported by and extends upward from a base portion 134. Although the frame is described and depicted below with a certain degree of particularity, it is to be appreciated that various embodiments of the stand can utilize other types of frame forms and structures and should not be construed to limit the frame to what is depicted and described herein.

As shown in FIGS. 4A and 5A, the base portion 134 of the frame 122 includes a right pivot support member 136 and a left pivot support member 138. The right pivot member 136 and the left pivot member 138 extend longitudinally from a front side to a rear side of the stand. Cylindrically-shaped bearing housings 140 are connected with forward and rear end portions 142, 144 of the right pivot support member 136 and the left pivot support member 138. As discussed in more detail below, portions of the lift device are pivotally connected with the bearing housings. Four frame feet 124 are connected with and extend downward from bottom sides 146 of the right pivot support member 136 and the left pivot support member 138 at the forward and rear end portions thereof. As such, the stand is supported by the four frame feet when placed in the stationary configuration. Although the some stand embodiments are depicted and described herein as being supported by feet extending downward from the frame, it is to be appreciated that some stand embodiments do not include feet, and as such, the frames rest directly on the support surface when the stand in is placed in the stationary configuration.

As previously mentioned, the upper portion of the frame extends upward from the base portion. As best shown in FIGS. 4A and 5A, the upper portion 130 of the frame 122 includes right and left forward vertical support members 148, 150 and right and left rear vertical support members 152, 154. The two forward vertical members 148, 150 are connected with and extend upward from top sides 156 of forward portions 142 of the right pivot support member 136 and the left pivot support member 138. Similarly, the two rear vertical members 152, 154 are connected with and extend upward from the top sides 156 of rear portions 144 of the right pivot support member 136 and the left pivot support member 138. The upper portion of the frame also includes four triangularly-shaped vertical gussets 158 to strengthen the connections between the vertical support members and the pivot support members. More particularly, two edges 160, 162 of the vertical gussets 158 are connected with the vertical support members and adjacent pivot support members. As shown in FIGS. 4A and 5A, the frame also includes a forward horizontal gusset 164 connected with the two forward vertical support members 148, 150, and a rear horizontal gusset 166 connected with the two rear vertical support members 152, 154.

As shown in FIGS. 4A-4E and 5A-5E, the right forward and rear vertical support members 148, 152 are generally parallel to each other and extend upward from the right pivot support member 136. Similarly, the left forward and rear vertical support members 150, 154 are generally parallel to each other and extend upward from the left pivot support member 138. The right forward and rear vertical support members 148, 150 and the left forward and rear vertical support members 152, 154 also extend upward in a direction inward toward each other. As shown in FIGS. 4C, 5C, and others, a right top side member 168 is connected with upper end portions 170 of the right forward and rear vertical members 148, 152. Similarly, a left top side member 172 is connected with upper end portions 170 of the left forward and rear vertical members 150, 154. As shown in FIGS. 2C and 3C, the frame can include one or more top cross members 173 connected with and extending between the right and left top members. As shown in FIGS. 4C, 5C, and others, the stand top 128 is connected with and supported by the right and left top members 168, 172 of the frame 122.

Various embodiments of the stand can utilize various forms of stand tops. For example, FIGS. 4A, 4C, 5A, 5C, and others, illustrate various views of one embodiment of the stand top 128. The stand top 128 is connected with the upper portion 130 of the frame 122 and provides an area upon which an object that is to be supported can be placed. As best shown in FIGS. 4C and 5C, the stand top includes a top plate 174 connected with a top plate pad 176. Although the stand top 128 depicted utilizes rivets 178 to connect the top plate pad 176 with the top plate 174, it is to be appreciated that the top plate pad can be connected with the top plate with other types of suitable means, such as screws or adhesive. In addition, although the stand top is illustrated as having a generally square shape, it is to be appreciated that stand tops having other shapes can also be utilized with the stand. It also to be appreciated that other stand tops embodiments have stand tops with support areas that are not substantially flat.

As previously mentioned, the user can place the stand in the mobile and stationary configurations by operating the lift device. One form of the lift device 120 is best shown in FIGS. 4A and 5A. The lift device 120 includes a first lift mechanism 180 and a second lift mechanism 182 operably coupled with each other and the frame 122. More particularly, the first lift mechanism and the second lift mechanism are pivotally connected with the frame through the bearing housings 140 connected with the forward and rear end portions 142, 144 of the right and left pivot support members 136, 138. The first and second lift mechanisms are also coupled with each other. It is to be appreciated that the first and second lift mechanisms can be coupled with each other in various ways. For example, as shown in FIGS. 4B and 5B, an interconnection member 184 couples the first and second lift mechanisms with each other. Although the interconnection member shown in FIGS. 4B and 5B is configured as a Heim joint assembly 186, it is to be appreciated that the interconnection member can be formed in other ways and should not be limited to the Heim joint shown and described herein. The interconnection member 184 acts to pivot the second lift mechanism 182 in response to pivotal movement of the first lift mechanism 180. For example, as the first lift mechanism pivots counterclockwise (direction A in FIG. 4B), the interconnection member pulls upward on the second lift mechanism, causing the second lift mechanism to pivot clockwise (direction B in FIG. 4B). Alternatively, as the first lift mechanism 180 pivots clockwise (direction A′ in FIG. 5B), the interconnection member 184 pushes downward on the second lift mechanism 182, causing the second lift mechanism to pivot counterclockwise (direction B′ in FIG. 5B).

As previously mentioned, the stand can include a plurality of wheels upon which the stand is rollingly supported when placed in the mobile configuration. For example, as shown in FIGS. 4C and 5C, the two front wheels 116 are rotatably connected with the second lift mechanism 182, and the two rear wheels 118 are pivotally connected with the first lift mechanism 180. As shown in FIG. 5B, the front wheels 116 are selectively brought into engagement with the support surface as the second lift mechanism is rotated in a clockwise direction (direction B in FIG. 4B). Similarly, as shown in FIG. 5B, the rear wheels 118 are selectively brought into engagement with the support surface as the first lift mechanism 180 is rotated in a counterclockwise direction (direction A in FIG. 4B).

FIGS. 2A-2C show the stand 100 in the stationary configuration. As best shown in FIGS. 2B and 2C, the stand is supported on the support surface 104 by the four downwardly extending feet 124. A user can place the stand in the mobile configuration shown in FIGS. 3A-3C by applying a force to the first lift mechanism 180 with his hand or foot, causing the first lift mechanism to rotate counterclockwise direction (direction A in FIG. 2C). As the first lift mechanism rotates, the interconnection member 184 causes the second lift mechanism 182 to simultaneously rotate in a clockwise direction (direction B in FIG. 2C). As the first and second lift mechanisms rotate in the counterclockwise and clockwise directions, respectively, the front and rear wheels 116, 118 are brought into engagement with the support surface 104 to rollingly support the stand thereon, as shown in FIGS. 3A-3C. As previously mentioned, the stand can include the locking device 126, such as shown in FIGS. 2C and 3C, that allows a user to lock the stand in the mobile and/or stationary configuration. As discussed in more detail below the locking device 126 allows a user to selectively connect the first lift mechanism 180 with the second lift mechanism 182 to maintain the stand in the mobile configuration.

To return the stand to the stationary configuration as shown in FIGS. 2A-2C, the user operates the locking device 126 to disconnect the first lift mechanism 180 from the second lift mechanism 182. The weight of the stand (and any object supported thereon) exerted on the front and rear wheels 116, 118 causes the first lift mechanism to pivot clockwise (direction A′ in FIG. 3C) and the second lift mechanism to pivot counterclockwise (direction B′ in FIG. 3C) until the downwardly extending feet 124 are brought into engagement with the support surface 104. As discussed in more detail below, the stand can also include a lift spring 188, such as shown in FIGS. 2C and 3C, connected with the frame 122 and the second lift mechanism 182. The lift spring acts to pull the first lift mechanism in the clockwise direction (direction A′ in FIG. 3C) and the second lift mechanism in the clockwise direction (direction B′ in FIG. 3C) through the interconnection member 184. As such, the lift spring helps to prevent the wheels from engaging the support surface when the stand in is the stationary configuration.

As previously mentioned, the first lift mechanism 180 of the lift device 120 is pivotally connected with the frame 122. When operating the lift device, the user pivots the first lift mechanism counterclockwise or clockwise (directions A and A′, respectively, in FIGS. 4B and 5B) to engage and disengage the rear wheels 118, respectively, with the support surface. FIGS. 4A-6B show various views of one form of the first lift mechanism 180 and associated components. As shown in FIG. 5A and others, the first lift mechanism includes a first lift link 190 connected with a first lift axle 192. Opposing end portions the first lift axle 192 are pivotally coupled with the bearing housings 140 connected with rear end portions of the right and left pivot support members 136, 138. More particularly, as shown in FIGS. 6A and 6B, the first lift axle is pivotally coupled with the bearing housings 140 through axle bolts 194 extending through lift bearings 196 housed within the bearing housings. As shown in FIG. 6B, the axle bolts 194 include a bolt head 198 connected with a shaft 200 defined a threaded portion 202 and a journal portion 204. Threaded apertures 206 located in the opposing end portions of the first lift axle 192 are adapted to receive the threaded portions of the axle bolts. When the threaded portions of the axle bolts are received within the threaded apertures, the journal portions 204 of the axle bolts 194 extend through bearing housings 140 and engage the inside of the bearings 196. Although FIG. 6B shows the details of the right end portion of the first lift axle, it is to be appreciated the that left end portion is substantially a mirror image of the right end portion.

As shown in FIGS. 4E, 5G, 6B and others, the rear wheels 118 are coupled with the first lift mechanism 180. More particularly, the rear wheels are configured as caster wheel assemblies 208 rotatably connected with the first lift axle 192 through rear caster wheel mounts 210. As shown in FIGS. 4D and 5D, the rear caster wheel mounts 210 are connected with the opposing end portions of the first lift axle 192 adjacent to the insides of the bearing housings 140. The rear caster wheel mounts have a generally square cross section defined by right 212, left 214, top 216, and bottom sides 218, and extend forwardly from the first lift axle. Two corresponding apertures 220 are located in right and left sides of the rear portions of the rear caster wheel mounts, which are adapted to accept and connect with the first lift axle. Therefore, the rear caster wheel mounts 210 pivot along with the first lift axle 192. The first lift link 190 and the caster wheel mounts 210 are also connected with the first lift axle 192 at different angular positions, as shown in FIGS. 4E and 5E, such that when caster wheel mounts 210 are generally parallel with the ground, the first lift link 190 extends forward and upward from the first lift axle 192.

As shown in FIGS. 4D and 5D, two corresponding apertures 222 are located in top and bottom sides 216, 218 of the forward portions of the rear caster wheel mounts 210. The apertures 222 in the top and bottom sides of the caster wheel mounts are adapted to accept and rotatably connect with connection posts 224 extending upwardly from the caster wheel assemblies 208. As such, the rear wheels 118 can orbit 360° relative to the rear caster wheel mounts 210 about an axis defined by the connection posts 224. Although the stand 100 includes two rear wheels coupled with the first lift mechanism, it is to be appreciated that other embodiments can include more or less than two rear wheels. In addition, the rear wheels need not be configured as caster wheels, but could include fixed wheel assemblies.

As discussed in more detail below with reference to FIGS. 2A-6B, pivoting the first lift link 190 downward acts to bring the two rear wheels 118 coupled with the first lift axle 192 into engagement with the support surface 104. Because the rear wheels are connected with forward end portion of the rear caster wheel mounts 210, the rear wheels are located forward of the axis of rotation defined by the first lift axle. As such, when the first lift axle rotates counterclockwise (direction A in FIG. 2C) relative to the bearing housings 140, such as when placing the stand in the mobile configuration, the rear wheels 118 swing downward and are brought into engagement with the support surface 104. As the first lift axle continues to rotate counterclockwise, the rear wheels move in a generally downward direction, while at the same time causing the rear end portions of the right and left pivot support members 136, 138 to be lifted upward as shown in FIG. 3C. The rear end portions of the pivot support members can be lifted upward a sufficient distance until a portion of the stand is rollingly supported by the two rear wheels.

As previously mentioned, the first lift link 190 of the first lift mechanism 180 is coupled with the frame 122 through the lift spring 188 and the second lift mechanism 182 through the interconnection member 184. In addition, the first lift link allows a user to apply forces with his hand or foot to the first lift mechanism in order to operate the lift device 120. As shown in FIGS. 2C, 3C, and 5A, the first lift link 190 includes a rear portion 226 defined by a first lift member 228 and a forward portion 230 defined by a second lift member 232. The first lift member 228 is connected with and is angularly offset from the second lift member 232. A foot pedal 234 is connected with the top surface of a forward portion of the second lift member 232. The foot pedal provides an area for a user to apply forces with his hand or foot to the first lift mechanism in order to operate the lift device. As shown in FIGS. 2C and 3C, a stand lock pivot shaft 236 is connected with the forward portion of the second lift member 232. As discussed in more detail below, the stand lock pivot shaft 236 provides a pivot connection between a portion of the locking device 126 and the first lift mechanism 180. Referring back to FIG. 5A, the first lift mechanism includes a pair of generally parallel and laterally spaced first link spines 238 extending longitudinally along the top surface of the first lift link 190. More particularly, the first link spines 238 generally extend from a rear portion of the first lift member 228 to a mid portion of the second lift member 232. A first cap screw 240 and a second cap screw 242 pass through first apertures 244 and second apertures 246 in the first link spines 238. The first cap screw 240 defines a first interconnection axle 248 and the second cap screw 242 defines a first lift spring axle 250. As discussed in more detail below, the interconnection member and lift spring are pivotally connected with the first interconnection axle and the first lift spring axle, respectively.

As previously mentioned, the lift device includes a second lift mechanism 182 pivotally connected with the frame 122. The second lift mechanism is also coupled with the first lift mechanism 180 so as to pivot as the first lift mechanism pivots. More particularly, when the user pivots the first lift mechanism counterclockwise or clockwise (directions A and A′, respectively, in FIGS. 2C and 3C), the second lift mechanism is caused to correspondingly pivot clockwise or counterclockwise (directions B and B′, respectively, in FIGS. 2C and 3C) to engage and disengage the front wheels 116, respectively, with the support surface 104. FIGS. 4A, 5A and others show various views of one form of the second lift mechanism and associated components. As shown in FIG. 5A, the second lift mechanism 182 includes right and left second lift links 252, 254, both connected with a second lift axle 256. Opposing end portions the second lift axle are pivotally coupled with the bearing housings 140 connected with forward end portions of the right and left pivot support members 136, 138. More particularly, the second lift axle is pivotally coupled with the bearing housings with the same components as described above with reference to the first lift axle shown in FIG. 6B. As such, the second lift axle 256 is pivotally coupled with the bearing housings 140 through axle bolts 194 extending through lift bearings 196 housed within the bearing housings.

As shown in FIGS. 4C and 5C, the front wheels 116 are coupled with the second lift mechanism 182. More particularly, the front wheels are coupled with the second lift mechanism in substantially the same manner as described above with reference to the rear wheels 118 and first lift mechanism 180. As such, the front wheels 116 are also configured as caster wheel assemblies 208 rotatably connected with the second lift axle 256 through front caster wheel mounts 258. As shown in FIG. 5A, the front caster wheel mounts are connected with the opposing end portions of the second lift axle 256 adjacent to the insides of the bearing housings 140. The front caster wheel mounts have substantially the same shape as the rear caster wheel mounts 210 discussed above, and are connected with and extend rearward from the second pivot axle. Therefore, the front caster wheel mounts 258 pivot along with the second lift axle 256. As shown in FIG. 5A, the right and left second lift links 252, 254 and the front caster wheel mounts 258 are connected with the second lift axle 256 at different angular positions such that when caster wheel mounts are generally parallel with the ground, the right and left second lift links extend rearward and upward from the second lift axle. In addition, the front wheels are connected with the front caster wheel mounts in substantially the same manner as described above with reference to the rear wheels 118 and corresponding rear caster wheel mounts 210. As such, the front wheels 116 can orbit 360° relative to the front caster wheel mounts 258 about an axis defined by the connection posts 224. Although the stand 100 includes two front wheels coupled with the second lift mechanism, it is to be appreciated that other embodiments can include more or less than two front wheels. In addition, the front wheels need not be configured as caster wheels, but could include fixed wheel assemblies.

As discussed in more detail below, because the first and second lift mechanisms 180, 182 are coupled together through the interconnection member 184, pivoting the first lift link 190 downward causes the right and left second lift links 252, 254 to pivot downward. Pivoting the right and left second lift links downward acts to bring the two front wheels 116 coupled with the second lift axle 256 into engagement with the support surface 104. Because the front wheels are connected with rear end portion of the front caster wheel mounts 258, the front wheels are located rearward of the axis of rotation defined by the second lift axle 256. As such, when the second lift axle rotates clockwise (direction B in FIG. 2C) relative to the bearing housings, such as when placing the stand in the mobile configuration, the front wheels 116 swing downward and are brought into engagement with the support surface. As the second lift axle 256 continues to rotate counterclockwise, the front wheels 116 move in a generally downward direction, while at the same time causing the forward end portions of the right and left pivot support members to be lifted upward. As shown in FIG. 3C, the forward end portions of the pivot support members 136, 138 can be lifted upward a sufficient distance until a portion of the stand 100 is rollingly by the two front wheels.

As previously mentioned, the right and left second lift links 252, 254 of the second lift mechanism 182 are coupled with the first lift link 190 of the first lift mechanism 182 through the interconnection member 184, which causes the second lift mechanism to correspondingly pivot as the first lift mechanism pivots. As shown in FIG. 5A, forward end portions of the right and left second lift links are connected with the second lift axle 256. The right and left second lift links are also laterally spaced and generally parallel to each other. A second interconnection axle 260 extends between and connects with rear end portions of the right and left second lift links. As discussed in more detail below, the interconnection member 184 is pivotally connected with the first interconnection axle 248 on the first lift mechanism 180 and the second interconnection axle 260 on the second lift mechanism 182. As such, pivotal movement of the first lift mechanism causes a corresponding pivotal movement of the second lift mechanism.

As previously mentioned, the first and second lift mechanisms can be coupled with each other in various different ways. For example, as shown in FIGS. 4B and 5B, the first and second lift mechanism are coupled with each other though the interconnection member configured as the Heim joint assembly 186. As previously mentioned, the Heim joint assembly is pivotally connected with the first interconnection axle 248 and with the second interconnection axle 260. Generally shown in FIGS. 2C and 3C, a Heim joint is a joint mechanism having two eye-bolts 262 threadedly connected with and extending from opposite ends of a tie-rod 264. A ball swivel 266 can also be located in the center of each eye-bolt. As shown in FIG. 2C, when the stand in is in the stationary configuration, the Heim joint extends downward and rearward from the second interconnection axle 260 to the first interconnection axle 248. When the stand in is in the mobile configuration shown in FIG. 3C, the Heim joint extends downward from the first interconnection axle 248 in a direction that is generally perpendicular to the support surface 104.

As previously mentioned, the lift device 120 can include the lift spring 188 to help prevent the wheels 116, 118 from engaging the support surface when the stand is placed in the stationary configuration. As shown in FIGS. 2C and 3C, a first end portion of the lift spring is connected with the lift spring axle 250 on the first lift link 190 and a second end portion of the lift spring is connected with the frame 122. More particularly, the second end portion of the lift spring 188 is connected with a lift spring mount 268 extending from a front side of the rear horizontal gusset 166. In operation, the lift spring 188 pulls the first lift mechanism 180 in the clockwise direction (direction A′ in FIG. 3C), which acts to disengage the rear wheels 118 from the support surface. Because the first lift mechanism 180 and the second lift mechanism 182 are coupled together through the interconnection member 184, the lift spring also causes the second lift mechanism 182 to pivot in the counterclockwise direction (direction B′ in FIG. 3C), which acts to disengage the front wheels from the support surface. As such, the lift spring acts on the first and second lift mechanisms to help maintain the stand in the stationary configuration as shown in FIG. 2C.

As previously mentioned, some embodiments of the stand can also include a lock that releasably holds the stand in the mobile and/or stationary configurations. It is to be appreciated that various types of locking devices can be utilized with the stand and should not be limited to that which is described and depicted herein. FIGS. 2C, 3C, 4A, 5A, and others show one form of the locking device 126 that can be used with various stand embodiments. As described in more detail below, the locking device 126 includes a body 270 pivotally connected with first lift link 190. The body 270 includes hooks 272 adapted to releasably connect the first lift mechanism 180 with the second lift mechanism 182 to maintain the stand in the mobile configuration. As shown in FIGS. 4A and 4B, the locking device body 270 includes a lock top 274 connected with first and second hooked sides 276, 278. The lock top includes a plate 280 having a bend 282 that defines a forward portion 284 and a rear portion 286. Upper portions of the hooked sides are connected with the rear portion of the lock top. The hooked sides also define axle holes adapted to receive a lock pivot axle 288 connected with a forward portion of the first lift link 190. As such, the lock body can pivot relative to the first lift link about the lock pivot axle. As discussed in more detail below with reference to FIG. 4A, the body 270 also includes an upper lock stop 290 and a lower lock stop 292 extending between the first and second hooked sides. The upper lock stop acts to limit the range of pivotal movement of the body relative to the first lift link.

Still referring to FIGS. 4A and 4B, lower forward portions of the hooked sides 276, 278 define rounded hooks 272 adapted to engage a portion of the second lift axle 256. The lower forward portions of the hooked sides also define wedged areas 294 below the hooks 272 wherein a forward edge 296 of the wedged area is adapted to engage the second lift axle 256 when the first lift link 190 is moved downward a sufficient distance, such as when placing the stand in the mobile configuration. As shown in FIG. 4A, the first lift link 190 extends between the upper lock stop 290 and a bottom side of the lock top 274. As shown in FIGS. 2C and 3C, a lock spring is located between lock top and the first lift link. The lock spring is a compression spring and is biased to press against the bottom side of the rear portion lock top and a top surface of the first lift link. As such, the lock spring causes the locking device body about the lock pivot axle in a clockwise direction (direction C in FIGS. 2C and 3C).

When the first lift link 190 is in an upward position, such as when the stand is in the stationary configuration, as shown in FIG. 2C, the lock spring 298 presses against the locking body 270 and the first lift link 190 to pivot the lock body about the lock pivot axle 288 in a clockwise direction (direction C in FIG. 2C) until the upper lock stop 290 abuts the bottom side of the first lift link. As described in more detail below, the first lift link is moved downward, causing the first lift mechanism to pivot counterclockwise (direction A in FIG. 2C) to place the stand in the mobile configuration shown in FIG. 3C. Moving the first lift link downward a sufficient distance causes the wedged areas 294 of the locking body to engage the second lift axle 256. As the wedged area of the locking body slides downward along the second lift axle, the locking body pivots counterclockwise (direction C′ in FIG. 3C) about the lock pivot axle 288. In turn, the lock spring 298 is compressed between the lock top 274 and the first lift link 190. As the first lift link continues to move downward until the wedged area of the hooked sides of the locking bottom move below the second lift axle, the lock spring decompresses and forces the locking body to pivot clockwise (direction C in FIG. 3C), which in turn engages the hooks 272 with the second lift axle 256. As such, when the stand is in the mobile configuration as shown in FIG. 3C, the lock spring acts to help hold the curved hooks in engagement with the second lift axle. As described in more detail below, the first lift mechanism 180 is decoupled from the second lift mechanism 182 by applying a downward force to the lock top 294, causing the locking body to pivot counterclockwise (direction C′ in FIG. 3C) to disengage the hooks from the second lift axle. In some embodiments, the hook opening is configured with an upwardly extending portion 300, such as shown in FIG. 2C. Such hook configurations may require the user to move the first lift link downward before the locking body can be pivoted counterclockwise in order to disengage the hooks from the second lift axle.

FIGS. 2A-2C and 4A-4E illustrate various views of the stand 100 in the stationary configuration, and FIGS. 3A-3C and 5A-5E illustrate various views of the stand in the mobile configuration. When the stand is in the stationary configuration, the lift spring 188 acts to hold the first lift mechanism 180 in an upward position such that rear wheels 118 are not acting to support the stand. Because the first lift mechanism and the second lift mechanism 182 are coupled through the interconnection member 184, the second lift mechanism is also held in an upward position such that the front wheels 116 are not acting to support the stand. As such, the stand is supported on the support surface by the four feet 124 extending downward from the frame 122. To place the stand in the mobile configuration, a downward force is applied to the foot pedal 234, which causes the first lift axle to pivot counterclockwise (direction A in FIG. 2C). As previously discussed, as the first lift axle 190 pivots counterclockwise, the rear wheels 118 swing downward and engage the support surface and act to lift the rear end portions of the pivot support members 136, 138 upward. At the same time, the right and left second lift links 252, 254 are pulled downward by the interconnection member 184, causing the second lift axle 256 to pivot clockwise (direction B in FIG. 2C). As previously discussed, as the second lift axle pivots clockwise, the front wheels swing downward and engage the support surface and act to lift the forward end portions of the pivot support members 136, 138 upward. As the first lift link is pivoted downward a sufficient distance, the front and rear wheels lift the feet 124 upward from the support surface until the stand is rollingly supported by the front and rear wheels.

As described above, the first lift link 190 can continue to be forced downward until the locking device 126 engages the second lift axle 256 in order to lock the stand in the mobile configuration. When the stand is locked the mobile configuration, the weight of the stand (and any object supported thereon) results in the application of upward forces on the front and rear wheels 116, 118, which tend pivot the first and second lift axles 192, 256 in the clockwise and counterclockwise directions, respectively. However, the upward forces on the rear wheels 118 are resisted by the engagement of the hooks 272 on the locking device 126 with the second lift axle, which prevents the first lift mechanism 180 from pivoting in the clockwise direction. Similarly, the upward forces on the front wheels 116 are resisted by the connection of the second lift mechanism 182 with the first lift mechanism (held in position by the locking device) through the interconnection member 184, which prevents the second lift mechanism from pivoting in the counterclockwise direction.

To return the stand to the stationary configuration from the mobile configuration, the user applies a downward force to the lock top 274 to pivot the locking body 270 counterclockwise (direction C′ in FIG. 3C) about the lock pivot axle 288, disengaging the hooks 272 from the second lift axle 256. Once the locking device 126 is decoupled from the second pivot axle, the frame 122 moves downward to place the feet 124 back into engagement with the support surface 104. As the frame moves downward, the rear and front wheels 116, 118 are forced upward relative to the frame, causing the first and second lift mechanisms 180, 182 to pivot clockwise and counterclockwise (directions A′ and B′ in FIG. 3C, respectively). In addition, as previously discussed, the lift spring 188 also pulls on the first lift link to help maintain the disengagement of the front and rear wheels with the support surface.

As previously mentioned, it is to be appreciated that with obvious mechanical modifications to the stands described and depicted herein, more or less than four wheels may be used. For example, one embodiment of the stand includes a total of three wheels, while another embodiment is configured with only two rollers. In addition, some embodiments can be configured with two rollers or wheels that are always engaged with the support surface and having two other rollers or wheels that are the selectively engaged with the support surface. In addition, it is to be appreciated that the stand need not be configured with four caster wheels. For example, some embodiments utilize only two caster wheels in combination with two fixed axle wheels, whereas other embodiments do not utilize any caster wheels. Other embodiments of the present invention also include wheels with other various features that can aid a user in maneuvering the stand when in the mobile configuration. For example, FIG. 6C shows one embodiment of a caster wheel 208 having a brush 302 connected thereto to help remove debris from the wheel path as the stand is rolled from along the support surface. It is also to be appreciated that other embodiments of the stand need not be configured with front and rear wheels that pivot in opposite directions when placing the stand in the stationary and mobile configurations, as described above with reference to the first stand embodiment. For example, other stand embodiments having minor structural differences from the first embodiment having front and rear wheels that pivot in the same direction.

Various accessories can be used in conjunction with the stand depending upon the needs of the user. For example, the stand can be configured to more stably secure the motorcycle and other objects to the stand top. For example, the stand 100 shown in FIGS. 7A and 7B includes a tie-down 304 to help secure the motorcycle 102 to the stand top 128. The tie-down 304 is configured as a belt 306 having hooks 308 connected with opposing end portions thereof. The hooks 308 can be adapted to connect with various components of the motorcycle, such as the foot pegs 114 as shown in FIG. 7A. As shown in FIGS. 7A and 7B, belt loops 310 are connected with and extending downward from the stand top provide guidance to the belt routing and help keep the belt connected with the stand top. As shown in FIGS. 7A and 7B, the belt 306 extends along a bottom side of the stand top and through the belt loops located on opposing sides of the stand top. The belt can also include a clasp 312 to allow a user to adjust the tension and/or length of the belt. Although the stand shown in FIGS. 7A and 7B includes two belt loops connected with the stand top, it is to be appreciated that the tie-down can be used with other embodiments of the stand having belt more or less than two belt loops that may be connected with different portions of the frame.

It is also to be appreciated that tie-downs other than a belt can be used in conjunction with the stand, such as cables, ropes, chains, and the like. In addition, other stand embodiments can include a mechanism connected therewith that allows a user to releasably connect a motorcycle or other object with the stand. For example, the stand 100 shown in FIGS. 8A and 8B includes right and left adjustable frame hooks 314, 316 to help a user more stably secure an object to the stand top 128. As best shown in FIG. 8B, the frame hooks 314, 316 are generally L-shaped, each including a hook portion 318 and a threaded portion 320. The threaded portion 320 extends through the stand top 128 and is threadedly connected with a knob 322 on a bottom side of the stand top 128. The knobs 322 are used to control the height at which the hook portions 318 extend above the stand top. The knobs can also be used to adjust the force at which the hooks hold the object onto stand top. FIG. 8A shows a portion of a motorcycle engine compartment 112 connected with stand top 128 through the frame hooks 314, 316.

Other embodiments of the stand can also include various features and accessories that can be used to aid a user while working on an object supported on the stand. For example, the stand can include a removable tray 323 in which a user can store items such as spare parts and tools, as shown in FIG. 9A. In another scenario, the stand can be configured with a fluid drain to allow for efficient collection and disposal of fluids, such as oil, that might otherwise spill or flow over the stand and onto the support surface. One embodiment of a stand top 324 configured with a fluid drain is shown in FIG. 9A. More particularly, the stand top 324 includes a recessed portion 326 defined in the top surface and having a drain aperture 328 located therein. As shown in FIG. 9A, stand 100 may also include a drain pipe 330 connected with the drain aperture 328 on the bottom side of the stand top 324. The drain pipe 330 can act to guide any fluid around the lift device 120 that may pass through the drain aperture 328. Depending upon the configuration of the object to be supported, the stand can include a removable stand top 332, such as shown in FIG. 9B, which includes a recessed area 334 therein that can be used to collect fluids from the object being supported on the stand. As shown in FIG. 9B, fluids are drained through an opening 336 in a side of the recessed area 334 to the outside of the stand top. It is to be appreciated that the stand top shown in FIG. 9B can also configured as a removable stand top that can be adapted to releasably connect with various types of stands. As such, the stand top shown in FIG. 9B can be made from various types of materials and can be configured in different ways. For example, one embodiment of a removable stand top similar to the embodiment shown in FIG. 9B is made of blow molded plastic.

It is to be appreciated that other embodiments of the present invention can utilize other forms of lift devices to selectively place the stand in the stationary and mobile configurations by engaging and disengaging wheels with the support surface than that which has been depicted and described above. For example, FIGS. 10A-17C show schematic representations of alternative stand embodiments, some having additional features and other variations of the lift device described above. The stands shown in FIGS. 10A-17C are depicted as having substantially similar frames to the stand described above with reference to the FIGS. 1-6C, and as such, have similarly named and labeled components.

FIGS. 10A and 10B are right side cross sectional views of a first alternative embodiment of a stand 338 with a lift device 340 having a threaded crank shaft 342 that controls the movement of first and second threaded links 344, 346, which allows a user to place the stand 338 in the mobile and stationary configurations. More particularly, the threaded links 344, 346 are coupled with first and second lift mechanisms 348, 350, respectively, and as such, the movement of the threaded links in a particular direction cause the lift mechanisms to engage and/or disengage the wheels 116, 118 with the support surface. As described above with reference to the first stand embodiment 100, the first and second lift mechanisms 348, 350 shown in FIGS. 10A and 10B each include first and second lift axles 192, 256 pivotally coupled with the frame 122. In addition, the rear and forward caster wheels 118, 116 are coupled with the first and second lift axles, respectively, through caster wheel mounts 210, 258, as described above.

As shown in FIGS. 10A and 10B, the threaded crank shaft 342 is rotatably supported by the frame 122 and includes a crank handle 352 that allows a user to rotate the threaded crank shaft. As discussed in more detail below, rotating the crank shaft forces the first and second threaded links 348, 350 to move away from or toward each other, which in turn, places the stand in the mobile or stationary configurations. As shown in FIGS. 10A and 10B, the first threaded link 344 is threadedly engaged with a rear threaded portion 354 of the threaded crank shaft 342, and the second threaded link 346 is threadedly engaged with a forward threaded portion 356. As such, when the crank shaft 342 is rotated counterclockwise as viewed from the front of the stand (direction D in FIG. 10A), the first and second threaded links 344, 346 move away from each other. In other words, the first threaded link 344 moves rearward along the rear threaded portion 354 of the crank shaft, and the second threaded link 346 moves forward along the forward threaded portion 356 of the crank shaft. Alternatively, when the crank shaft is rotated clockwise as viewed from the front of the stand (direction D′ in FIG. 10B), the first and second threaded links move toward each other. In other words, the first threaded link 344 moves forward along the rear threaded portion 354 of the crank shaft, and the second threaded link 346 moves rearward along the forward threaded portion 356 of the crank shaft. Although the treaded links shown in FIGS. 10A and 10B move in opposing directions when the threaded crank shaft is rotated, it is to be appreciated that other stand embodiments can include a threaded crank shaft configured such that the threaded links move in the same direction when the crank shaft is rotated.

As previously mentioned, the first and second threaded links 344, 346 are coupled with the first and second lift mechanisms 348, 350. More particularly, the first lift mechanism 348 includes right and left first lift links 358 having opposing end portions pivotally connected with the first threaded link 344 and the rear caster wheel mounts 210. Similarly, the second lift mechanism 350 includes right and left second lift links 360 having opposing end portions pivotally connected with the second threaded link 346 and the front caster wheel mounts 258. Since FIGS. 10A and 10B are cross sectional views of the stand 338, only the left first lift link and the left second lift link are shown. When the first threaded link 344 moves rearward along the crank shaft, the first lift links 358 push the rear caster mounts 210 downward, which in turn causes the first lift axle 192 to pivot counterclockwise (direction A in FIG. 10A). As described above with reference to the first stand embodiment shown in FIGS. 1-6C, as the first lift axle pivots counterclockwise, the rear wheels 118 are brought into engagement with the support surface 104. Similarly, when the second threaded link 346 moves forward along the crank shaft 342, the second lift links push the front caster mounts 258 downward, which in turn, causes the second lift axle 256 to pivot clockwise (direction B in FIG. 10A). As described above with reference to the first stand embodiment shown in FIGS. 1-6C, as the second pivot axle pivots clockwise, the front wheels 116 are brought into engagement with the support surface 104. Alternatively, when the first threaded link 344 moves forward along the crank shaft 342, the first lift links 358 pull the rear caster mounts 210 upward, which in turn causes the first pivot axle 192 to pivot clockwise (direction A′ in FIG. 10B). As described above with reference to the first stand embodiment 100 shown in FIGS. 1-6C, as the first pivot axle pivots clockwise, the rear wheels 118 are disengaged from the support surface. Similarly, when the second threaded link 346 moves rearward along the crank shaft 342, the second lift links 360 pull the front caster mounts 258 upward, which in turn, causes the second pivot axle to pivot counterclockwise (direction B′ in FIG. 10B). As described above with reference to the first stand embodiment shown in FIGS. 1-6C, as the second pivot axle pivots counterclockwise, the front wheels are disengaged from the support surface.

FIG. 10A shows the stand 338 in the stationary configuration. To place the stand in the mobile configuration as shown in FIG. 10B, the user turns the handle 352 on the threaded crank shaft counterclockwise (direction D shown in FIG. 10A). As the threaded crank shaft 342 turns counterclockwise, the threaded engagement between the crank shaft and the first and second threaded links 344, 346 forces the first and second threaded links away from each other. As the first threaded link 344 moves rearward, the first lift links 358 push downward on the rear caster mounts 210, engaging the rear wheels 118 with the support surface 104. Similarly, as the second threaded link 346 moves forward, the second lift links 360 push downward on the front caster mounts 258, engaging the front wheels 116 with the support surface. The user can continue to turn the crank shaft until the stand is rollingly supported by the front and rear caster wheels, as shown in FIG. 10B. Because the lift mechanisms 348, 350 are threadedly coupled with the crank shaft, the stand shown in FIGS. 10A and 10B does not require a separate locking device to maintain the stand in the mobile configuration. It is also to be appreciated that the first stand embodiment described above with reference to FIGS. 1-6B could be modified to include a threaded crank shaft similar that described above with reference to FIGS. 10A and 10B to couple the first and second lift mechanisms together while at the same time functioning as a locking device.

To return the stand 338 to the stationary configuration, the user rotates the crank shaft 342 clockwise as viewed from the front of the stand (direction D′ shown in FIG. 10B). As the threaded crank shaft turns clockwise, the threaded engagement between the crank shaft and the first and second threaded links 344, 346 forces the first and second threaded links toward each other. As the first threaded link 344 moves forward, the first lift links 358 pull upward on the rear caster mounts 210, disengaging the rear wheels 118 with the support surface 104. Similarly, as the second threaded link 346 moves rearward, the second lift links 360 pull upward on the front caster mounts 258, disengaging the front wheels 116 with the support surface. The user can continue to turn the crank shaft until the wheels are lifted upward so that the stand is supported by the frame, as shown in FIG. 10A.

FIGS. 11A and 11B are right side cross sectional views of a second alternative embodiment of a stand 362 with two front wheels 116 that are always engaged with the support surface 104 and two rear wheels 118 that are the selectively engaged with the support surface. More particularly, the front wheels 116 are coupled with the frame 172 through a front base member 364, which is connected with the forward end portions of the right and left pivot support members 136, 138. As such, unlike the above described embodiments, the front wheels do not pivot relative to the frame and are in contact with the support surface 104 when the stand is in the mobile and stationary configurations. The rear wheels 118 are coupled with a lift mechanism 366 that allows a user to selectively place the rear wheels into engagement with the support surface. The lift mechanism 366 can include right and left lift links 368 connected with a lift axle 370. Since FIGS. 11A and 11B are cross sectional views of the stand, only the left lift link is shown. The lift axle 370 pivotally coupled with the frame 122 is similar to the first lift axle 192 described above with reference to the first stand embodiment. However, unlike the first stand embodiment, the rear wheels 118 in FIGS. 11A and 11B are connected with the right and left lift links 368, as opposed to caster wheel mounts. A handle 372 connected with forward end portions of the right and left lift links 368 allows a user to move the lift links downward and upward, which in turn, causes the lift axle 370 to pivot counterclockwise (direction A in FIG. 11A) and clockwise (direction A′ in FIG. 11B), respectively. As such, the movement of the right and left lift links in a particular direction engages or disengages the rear wheels with the support surface.

Similar to the first lift mechanism described above with reference to the first stand embodiment, the lift mechanism includes a lift spring 188 to help prevent the rear wheels 118 from engaging the support surface when the stand 362 is placed in the stationary configuration. As shown in FIGS. 11A and 11B, a first end portion of the lift spring 188 is connected with lift link 368, and a second end portion of the lift spring 188 is connected with the frame 122. More particularly, the second end portion of the lift spring 188 is connected with a lift spring mount extending from the rear horizontal gusset 166. In operation, the lift spring 188 pulls the lift mechanism 366 in the clockwise direction (direction A′ in FIG. 11B), which acts to disengage the rear wheels from the support surface. As such, the lift spring acts on the lift mechanisms to help maintain the stand in the stationary configuration.

As described above with reference to the first stand embodiment 100, the stand 362 shown in FIGS. 11A and 11B can also include a lock 374 that releasably holds the stand in the mobile and/or stationary configurations. As previously mentioned, various types of locking devices can be utilized with the stand and should not be limited to that which is described and depicted herein. FIG. 11C shows one form of the locking device 374 that can be used with stand. In particular, the locking device 374 includes a locking member 376 connected with the forward horizontal gusset 164 and the front base member 364. The locking member 376 includes a J-shaped aperture 378 defined by a relatively long channel portion 380 and a relatively short channel portion 382, both extending upward from a base channel portion 384. The handle 372 connected with the lift links 368 extends through the J-shaped aperture 378. As such, the handle can be positioned by the user within the J-shaped aperture such that the handle extends through the relatively long channel portion 380 or the relatively short channel portion 382 in order to selectively configure the stand in the mobile and stationary configurations. As described in more detail below, the handle is positioned to extend through the relatively long channel portion of the J-shaped aperture to place the stand in the stationary configuration, as shown in FIG. 11A. When the handle is extending through the relatively long channel portion, the handle is able to move a sufficient distance upward, allowing the lift axle 370 to pivot clockwise a sufficient amount in order to disengage the rear wheels 118 with the support surface. Alternatively, the handle is positioned to extend through the relatively short channel portion 382 of the J-shaped aperture to place the stand in the mobile configuration, as shown in FIG. 11B. As such, the handle abuts a top edge 386 of the relatively short channel portion, which in turn, holds the handle in a position that maintains the rear wheels 118 in engagement with the support surface.

As shown in FIG. 11A, when the stand 362 is in the stationary configuration, the lift spring 188 acts to hold the lift mechanism 366 in an upward position such that rear wheels 118 are not supporting the stand on the support surface. As such, the stand is supported on the support surface by a portion of the frame 122 and the two front wheels 116. In addition, the handle 372 is positioned to extend through the relatively long channel portion 380 of the J-shaped aperture 378 shown in FIG. 11C. To place the stand 362 in the mobile configuration, a downward force is applied to the handle 372, which causes the lift axle 370 to pivot counterclockwise (direction A in FIG. 11A). As the lift axle pivots counterclockwise, the rear wheels 118 swing downward and engage the support surface 104 and lift the rear end portions of the pivot support members 136, 138 upward. As the lift link is pivoted downward a sufficient distance, the rear wheels lift the frame upward from the support surface until the stand is rollingly supported by the front and rear wheels.

As described above, the lift link 368 can continue to be forced downward until the handle 372 can be maneuvered across the base channel portion 384 and into the relatively short channel portion 382 of the J-shaped aperture 378 shown in FIG. 11C in order to lock the stand in the mobile configuration. When the stand is locked the mobile configuration, the weight of the stand (and any object that is supported thereon) results in the application of upward forces on the front and rear wheels 116, 118, which tend pivot the lift axle 370 in the clockwise direction. However, the upward forces on the rear wheels are resisted by the engagement of the handle 372 on the upper edge 386 of the relatively short channel portion 382 of the J-shaped aperture 378, which prevents the lift mechanism 366 from pivoting in the clockwise direction.

To return the stand 362 to the stationary configuration shown in FIG. 11A from the mobile configuration shown in FIG. 11B, the user applies a downward force to the handle 372 toward the base portion 384 of the J-shaped aperture 378 shown in FIG. 11C, allowing the user to maneuver the handle 372 across the base portion 384 and into the relatively long channel portion 380 of the J-shaped aperture. Once the handle is positioned to extend through the relatively long channel portion of the J-shaped aperture, the frame 122 moves downward to place the rear of the frame back into engagement with the support surface. As the frame moves downward, the rear wheels 118 are forced upward relative to the frame, causing the lift mechanism 366 to pivot clockwise (direction A′ in FIG. 11B). In addition, as previously discussed, the lift spring 188 also pulls upward the lift links 368 to help maintain the disengagement of the rear wheels 118 from the support surface 104.

As previously mentioned, the stand embodiments can include various types of locking devices. FIGS. 11D-11F show another form of a locking device 388 that can be used with the stand embodiment discussed above with reference to FIGS. 11A and 11B and others. As shown in FIGS. 11D-11F, the locking device 388 includes a locking member 388 connected with the forward horizontal gusset 164 and the front base member 364. The handle 372 connected with the lift mechanism 366 extends through a substantially vertically oriented channel 392 in the locking member 390. The locking device also includes a latch 394 pivotally connected with the locking member 390 through a latch axle 396. The latch acts to maintain the stand in the mobile configuration by holding the handle downward in a lower portion 398 of the channel 392, as shown in FIG. 11F. As discussed in more detail below, the latch can also be pivoted to allow the handle 372 to move upward toward an upper portion 400 of the channel 392 to place the stand in the stationary configuration, as shown in FIG. 11D.

As shown in FIGS. 11D-11F, the latch 394 includes an engagement portion 402 connected with a latch handle portion 404. The engagement portion 402 is defined by a downward facing edge 406 and a sloped edge 408. A latch stop 410 extending outward from the locking member 390 adjacent a left side of the channel 392 acts to limit the pivotal rotation of the latch about the latch axle 396 in the clockwise direction (direction D′ in FIG. 11E). More particularly, as shown in FIGS. 11D and 11F, the sloped edge 408 of the latch 394 is engaged with the latch stop 410 such that the latch is prevented from further rotating in the clockwise direction. The locking device also includes a latch spring 412 that is biased to hold the latch in a locking position shown in FIGS. 11D and 11F. The locking mechanism does not include a physical stop that limits the rotation of the latch in the counterclockwise direction (direction D in FIG. 11E), which allows the latch to be pivoted to a released position shown in FIG. 11E.

In operation, the handle 372 can be moved downward or upward by the user within the channel 392 in order to selectively configure the stand 362 in the mobile and stationary configurations. More particularly, the handle 372 is positioned downward to extend through the lower portion 398 of the channel 392 to place the stand in the mobile configuration, as shown in FIG. 11F. As illustrated, the handle 372 is positioned below and is abutting the downward facing edge 406 of the latch 394. Because the pivotal rotation of the latch in the clockwise direction is limited by the latch stop 410, the handle 372 is held a the downward position. When in the handle is in the downward position shown in FIG. 11F, the rear wheels 118 are engaged with the support surface and the stand is held in the mobile configuration. To place the stand in the stationary configuration, a user pivots the latch 394 counterclockwise (direction D in FIG. 11E) with the latch handle 404 so that the handle 372 connected with the lift mechanism 366 is free to move upward within the channel 392. When in the handle is in an upward position, the rear wheels 118 are disengaged from the support surface, as discussed above with reference to FIG. 11A.

To return the stand to the mobile configuration, the handle 372 is moved downward in the channel 392, as shown in FIG. 11E. Moving the handle downward within the channel a sufficient distance causes the handle 372 to engage the sloped edge 408 of the latch 394. As the handle 372 continues to slide downward along the sloped edge of the latch, the latch pivots counterclockwise (direction D in FIG. 11E) about the latch axle 396. As the latch pivots counterclockwise, the latch spring 412 is stretched. The handle 372 continues to move downward until the handle moves below the intersection of the of the sloped edge 408 and the downward facing edge 406 of the latch 394, at which point the stretched lock spring pulls the latch in the clockwise direction, which in turn places the downward facing edge 406 above the handle 372. As such, the stand is maintained in the mobile configuration by the abutting relationship between the handle and the downward facing edge of the latch.

FIGS. 12A and 12B are right side cross sectional views of a third alternative embodiment of a stand 414 with a lift device 416 including first and second lift mechanisms 418, 420 operably coupled with each other and the frame 122. As discussed above with reference to the first stand embodiment, the first lift mechanism 418 and the second lift mechanism 420 are pivotally connected with the frame 122. The stand also includes a lift spring 188 connected with the frame 122 and the first lift mechanism 418. As such, the lift spring functions in a manner substantially similar to the lift spring described above with reference to the first embodiment. In addition, similar to the first embodiment, the first and second lift mechanisms can also include one or more first and second lift links 422, 424, respectively. However, unlike the first embodiment, the first and second lift mechanisms are coupled with each other through an interconnection member 426 in the form of an interconnection roller 428 rotatably connected with the first lift mechanism 418, as opposed to a Heim joint assembly described above. In addition, the front and rear wheels 116, 118 are illustrated as being connected directly with the first and second lift links 422, 424, as opposed to being connected with caster wheel mounts. Further, the second lift mechanism includes a handle 430 connected with the second lift links 424 that allows a user to selectively place the stand in the mobile and stationary configurations. It is to be appreciated that the stand shown in FIGS. 12A and 12B can also include various forms of locking devices, such as those described above with reference to FIGS. 11C-11D, to lock the handle 430 in a downward position to maintain the stand in the mobile configuration.

The interconnection roller 428 shown in FIGS. 12A and 12B acts to pivot the second lift mechanism 420 in response to pivotal movement of the first lift mechanism 418 when placing the stand in the mobile configuration. For example, FIG. 12A shows the stand in the stationary configuration. When placing the stand in the mobile configuration as shown in FIG. 12B, the user pushes downward on the handle, which causes the second lift mechanism to pivot clockwise (direction B in FIG. 12A). As the second lift mechanism pivots clockwise, the second lift link 424 pushes downward on the first lift link 422 causing the first lift mechanism 420 to pivot counterclockwise (direction A in FIG. 12A). As the first and second lift mechanisms pivot downward, the interconnection roller 428 rolls forwardly along a portion of the length of the second lift link 424. Alternatively, when returning the stand to stationary configuration as shown in FIG. 12A, the handle 430 is moved upward, which causes the second lift mechanism to pivot counterclockwise (direction B′ in FIG. 12B). As the second lift mechanism pivots counterclockwise, the first lift link 422 is pulled upward by the lift spring 188, causing the first lift mechanism 418 to pivot counterclockwise (direction A′ in FIG. 12B). The lift spring can also pull upward on the first lift link 422 so as to maintain contact between the interconnection roller 428 and the second lift link 424. As such, the interconnection roller can roll rearwardly along a portion of the length of the second lift link as the first and second lift mechanism pivot upward.

FIGS. 13A and 13B are right side cross sectional views of a fourth alternative embodiment of a stand 432 with a lift device 434 including first and second lift mechanisms 436, 438 operably coupled with each other and the frame 122. The stand 432 shown in FIGS. 13A and 13B is substantially similar to the stand 414 discussed above with reference to FIGS. 12A and 12B, except the first lift and second lift mechanisms are not coupled with each other through an interconnection roller. Instead, the first and second lift mechanisms 436, 438 shown in FIGS. 13A and 13B are coupled with each other through a pin and slot arrangement 440. More particularly, a second lift link 442 of the second lift mechanism 438 includes a slot 444 adapted to receive a pin 446 extending from a first lift link 448 on the first lift mechanism 436. As such, the pin 446 slides back and forth along a portion of the length of the slot 444 as the first and second lift mechanisms are pivoted up and down when placing the stand 432 in the stationary and mobile configurations.

FIGS. 14A and 14B are right side cross sectional views of a fifth alternative embodiment of a stand 450 with a lift device 452 including first and second lift mechanisms 454, 456 operably coupled with each other and the frame 122. As discussed above with reference to the first stand embodiment 100, the first lift mechanism 454 and the second lift mechanism 456 are pivotally connected with the frame 122. In addition, similar to the first embodiment, the first and second lift mechanisms 454, 456 can also include one or more first and second lift links 458, 460, respectively. The first and second lift mechanisms are also coupled with each other through an interconnection member 462 in the form of an interconnection link 464 pivotally connected with the first lift link 458 and the second lift link 460. Further, the first lift mechanism 454 includes a handle or foot pedal 466 connected with the first lift link that allows a user to selectively place the stand in the mobile and stationary configurations. It is to be appreciated that the stand 450 shown in FIGS. 14A and 14B can also include various forms of locking devices, such as those described above with reference to FIGS. 11C-11E, to lock the handle or foot pedal in a downward position to maintain the stand in the mobile configuration.

However, unlike the first stand embodiment, front and rear caster wheel mounts 468, 470 are illustrated in FIGS. 14A and 14B as being coupled with the first and second lift axles 192, 256 and the frame 122 through linkage assemblies 472. The linkage assemblies 472 maintain the caster wheel mounts in a substantially vertical orientation with respect to the support surface 104 as the wheels 116, 118 are raised and lowered when placing the stand in the stationary and mobile configurations. Maintaining a substantially vertical caster wheel mount orientation helps to reduce sheer forces on the caster wheel assemblies, especially when placing the stand in the mobile configuration while supporting a relatively heavy object. As shown in FIGS. 14A and 14B, the caster wheel mounts 468, 470 are coupled with the first and second lift axles 192, 256 and the frame 122 through lower pivot links 474 and upper pivot links 476, respectively. First end portions 478 of the lower pivot links are fixedly connected with the first and second lift axles 192, 256. As such, the lower pivot links 474 pivot along with the first and second axles. Second end portions 480 of the lower pivot links 474 are pivotally connected with lower end portions of the caster wheel mounts 468, 470. Still referring to FIGS. 14A and 14B, first end portions 482 of the upper pivot links 476 are pivotally connected with the frame 122, and second end portions 484 of the upper pivot links 476 are pivotally connected with upper end portions of the caster wheel mounts 468, 470.

As previously mentioned, the caster mount linkage assemblies 472 help maintain the caster wheel mounts 468, 470 in a substantially vertical orientation when placing the stand 450 in the mobile and stationary configurations. For example, FIG. 14A shows the stand 450 in the stationary configuration. When placing the stand in the mobile configuration as shown in FIG. 14B, the user pushes downward on the handle 466, which causes the first lift mechanism 454 to pivot counter counterclockwise (direction A in FIG. 14A). As the first lift mechanism pivots counterclockwise, the second lift link 460 is pulled downward by the interconnection link 464, causing the second lift mechanism 456 to pivot clockwise (direction B in FIG. 14A). As the first and second lift mechanisms pivot downward, the upper and lower pivot links 476, 474 swing downward while maintaining the caster wheel mounts in a substantially vertical orientation with respect to the support surface 104. Alternatively, when returning the stand to stationary configuration as shown in FIG. 14A, the handle 466 is moved upward, which causes the first lift mechanism to pivot clockwise (direction A′ in FIG. 14B). As the first lift mechanism pivots clockwise, the second lift link 460 is pushed upward by the interconnection link 464, causing the second lift mechanism 456 to pivot counterclockwise (direction B′ in FIG. 14B). As the first and second lift mechanisms pivot upward, the upper and lower links 476, 474 swing upward while maintaining the caster wheel mounts in a substantially vertical orientation with respect to the support surface.

As previously discussed, the stand embodiment 450 shown in FIGS. 14A and 14B provides linkage assemblies that maintain the caster wheel mounts in substantially vertical orientations as the wheels are engaged and disengaged with the support surface. It is to be appreciated that the wheels can be coupled with the frame and lift mechanisms in other ways to provide for similar caster wheel movements. For example, FIGS. 15A and 15B show an alternative manner in which the wheels can be coupled with the frame and the lift mechanisms. As illustrated, the connection post 224 of the caster wheel 208 assembly can extend upward through an aperture 486 in the frame 122. As such, the connection post 224 is adapted to slide up and down through the aperture 486 in the frame when placing the stand in the mobile and stationary configurations. FIGS. 15A and 15B also illustrate that the wheel assemblies 208 need not be connected directly with a lift mechanism 488, but instead, can be configured in an abutting relationship with the lift mechanism. It is to be appreciated that the caster wheel assembly shown in FIGS. 15A and 15B can also be spring loaded to maintain the wheel in a desired orientation. For example, the wheel assembly could include a spring to maintain the wheel in an upward orientation, as shown in FIG. 15A, when the stand is placed in the stationary configuration.

Although many of the stand embodiments described above include lift mechanisms having at least one lift link or lever that is actuated through a handle or foot pedal to engage and/or disengage the wheels with support surface, it is to be appreciated that other forms lift mechanisms can be utilized on other embodiments of the stand. For example, FIGS. 16A and 16B show a sixth alternative embodiment of the stand 490 including a lift mechanism 492 connected with the stand top 494. More particularly, the lift mechanism 492 includes a top plate 496 and a bottom plate 498 connected with opposing end portions of a hydraulic jack 500. The top plate 496 is also connected with the stand top 494. Front and rear wheels 116, 118 are connected with the bottom plate 498. The lift mechanism also includes a handle 502 to actuate the hydraulic jack 500 to raise and lower the wheels in order to place the stand 490 in the mobile and stationary configurations. FIG. 16A shows the stand in the stationary configuration, and FIG. 16B shows the stand in the mobile configuration. Although the embodiment in FIGS. 16A and 16B is described as having a lift mechanism utilizing a hydraulic jack, it is to be appreciated that other types of jacks can be used, such as a conventional mechanical ratchet-type jack.

Although the stand embodiments described above utilize lift mechanisms that raise and lower wheels connected therewith to place the stand in the stationary and mobile configurations, it is to be appreciated that other stand embodiments can include wheels that are connected with the frame. In these embodiments, the lift mechanism is used to raise and lower the frame to engage and disengage the wheels with the support surface. For example, FIGS. 17A-17C show a seventh alternative stand embodiment 504 having front and rear wheels 116, 118 connected with the frame 122 and a lift mechanism 506 that selectively places the wheels in engagement with the support surface by raising and lowering the frame.

As shown in FIGS. 17A and 17B, the lift mechanism 506 includes a top plate 508 and a bottom plate 510 connected with opposing end portions of a jack body 512. The jack body 512 includes a top portion 514 adapted to slidingly receive a bottom portion 516, as shown in FIG. 17C. The lift mechanism 506 also includes an actuator 518 having a forward handle 520 and rear handle 522, which are used to place the stand 504 in the stationary and mobile configurations. As shown in FIGS. 17A-17C, a lower portion 524 of the actuator 518 is pivotally connected with the bottom portion 516 of the jack body 512, and a pin 526 connected with an upper portion 528 of the actuator 518 is slidingly received within a slot 530 connected with the top portion 514 of the jack body 512. Pivotal movement of the actuator causes the jack body to extend and retract, which in turn, places the stand in the stationary and mobile configurations, respectively. For example, FIG. 17A shows the stand 504 in the stationary configuration, wherein the rear handle 522 is located in a downward position, and the jack body 512 is in an extended configuration. As such, the stand is supported by the bottom plate 510 and the wheels 116, 118 are disengaged with the support surface 104. Although the actuator is coupled with the top portion of the jack body through a pin and slot arrangement, it is to be appreciated that the actuator can be coupled with the top portion of the jack body in other ways, such as with one or more link members.

To place the stand 504 in the mobile configuration shown in FIG. 17B, the front handle 520 is moved downward, causing the actuator to pivot counterclockwise (direction A in FIG. 17B). As the actuator pivots counterclockwise, the pin 526 moves forward in the slot 530, which causes the bottom portion 516 of the jack body 512 to retract upward into the top portion 514 of the jack body 512. As such, the bottom plate 510 moves upward until the stand is rollingly supported by the wheels. To return the stand to the stationary configuration shown in FIG. 17A, the rear handle 522 is moved downward, causing the actuator to pivot clockwise (direction A′ in FIG. 17A). As the actuator 518 pivots clockwise, the pin 526 moves rearward in the slot 530, which causes the bottom portion 516 of the jack body 512 to extend downward from inside the top portion 514 of the jack body 512. As such, the bottom plate moves downward until the stand is supported by the bottom plate. It is to be appreciated that other types of lift mechanisms can be used with the embodiment shown in FIGS. 17A-17C, such as a hydraulic jack or a conventional mechanical ratchet-type jack.

Although the stands described above include various types of lift devices used to engage and/or disengage wheels with the support surface to allow a user to configure the stand in mobile and stationary configurations, it is to be appreciated that other stand embodiments may include more than one lift devices that perform two different functions. For example, the schematic representation of a stand 532 shown in FIG. 18 can include a first lift device 534 that is configured to engage and disengage the wheels 116, 118 with support surface, and a second lift device 536 that is configured to adjust the overall height of the stand. In such a configuration, the stand 532 shown in FIG. 18 could be place in the mobile configuration with the first lift device and rolled under an object that is to be lifted. Once the stand is properly placed under the object, the second lift device can be used to increase the overall height of the stand to lift the object.

As previously mentioned, the stands should not be construed to be limited to the frame structures shown and described herein. As such, it is to be appreciated that various types of stand frame structures can be utilized with various types of lift devices that allow a user to selectively configure the stand between mobile and stationary configurations. For example, FIGS. 19A-19B illustrate a stand 538 with an alternative frame structure that can be selectively configured between expanded and storage configurations. More particularly, the stand shown in FIGS. 19A-19B includes a stand top 540 supported by a collapsible frame 542. The frame 542 includes an upper portion 544 and a base portion 546. The base portion 546 can be configured similarly to the base portion described above with reference to the first stand embodiment. However, the upper portion 544 of the frame 542 is configured differently from the first stand embodiment. More particularly, as shown in FIGS. 19A-19B, the upper portion of the frame includes right and left rear support legs 548 pivotally connected with right and left forward support legs 550 at first pivotal connections 547. Lower end portions of the rear support legs 548 are pivotally connected with rear end portions of the right and left pivot support members 136, 138 at second pivotal connections 549, and upper end portions of the forward support legs 550 are pivotally connected with a rear portion of the stand top 540 at third pivotal connections 551. The pivotal connections between the support legs, the stand top, and the base portion allow a user to fold the stand frame into a relatively flat storage configuration as shown in FIG. 19B.

FIG. 19A shows the stand frame 542 in an expanded configuration wherein the rear support legs 548 extend upward and forward from second pivotal connections 549. The forward portion of the stand top 540 rests on the upper end portions of the rear support legs 548. More particularly, as well as providing vertical support to the stand top, the upper end portions of the rear support legs 548 abut a ledge 541 extending downward from the stand top prevents the rear support legs from sliding out from under the stand stop. The forward support legs 550 extend downward and forward from the third pivotal connections 551. Lower end portions of the forward support legs abut stops 552 extending upward from the right and left pivot support legs 136, 138. The abutting relationship of the support legs with the stops and stand top in combination with the pivotal connections maintains the stand in an expanded configuration. To place the stand in a storage configuration, such as shown in FIG. 19B, the user disengages the rear support legs from the stand top by pivoting the stand top upward about the third pivotal connections, while at the same time, disengaging the forward support legs from the stops on the pivot support members by pivoting the frame upwards about the second pivotal connections. Once the support legs are disengaged from the stops and the stand top, the frame can be collapsed pushing the stand top downward, as shown in FIG. 19B.

FIG. 20 depicts a schematic representation of a lift base 554 having a base 555 adapted to removably support a stationary motorcycle stand 556 thereon. The lift base 554 can include wheels 116, 118 and a lift device 558 similar to that which has been described above with reference to the stand embodiments. As such, a user can selectively configure the lift base between a stationary configuration and a mobile configuration. In use, a user can place the stationary stand 556 on the base 555 in locations where it may be desirable to provide the benefits of a mobile stand, such as in a garage. The stationary stand 556 can also be removed from the base 555 and used in a location where it may be desirable to utilize only the stationary stand, such as at a motorcycle track. It is to be appreciated that the lift base can utilize various types of lift devices as well as various quantities and types of wheels described herein. In addition, the lift base can be configured to support various types and sizes of stands.

FIG. 21 shows one embodiment of a lift base 560 configured to support a stationary motorcycle stand 562. The lift base 560 includes a lift device 564 that is substantially similar to the lift device 120 described above with reference to the first stand embodiment 100. As such, the user can place the stationary stand 562 on the base 555 and operate the lift device to configure the lift base between stationary and mobile configurations. When placed in the mobile configuration, the user can easily roll the stationary stand by itself or while supporting an object such as a motorcycle along the support surface between various locations.

As shown in FIG. 21, the base 555 can be configured as a tray 566 adapted to receive and support the stationary motorcycle stand 562. The tray 566 includes first 568, second 570, third 572, and fourth sides 574 extending upward from a bottom side 576. Although the lift device 564 is similar to the lift device shown and described above with reference to FIGS. 1-6B, it is to be appreciated that the lift base 560 can utilize other types of lift devices described and depicted herein. As shown in FIG. 21, the lift base includes a first lift axle 578 and a second lift axle 580 pivotally connected with the first and third sides 568, 572 of the tray 566. The first and second lift axles also extend along the outsides of the second and fourth sides 570, 574 of the tray, respectively. As shown in FIG. 21, the first link and second lift mechanisms 180, 182 are located outside the tray 566 adjacent the first side 568. In use, the stationary stand 562 can be placed inside the tray such that the stationary stand is supported by the bottom side 576 of the tray 566. The sides of the tray help prevent the stand from sliding off the lift base while rolling the stand and lift base when in the mobile configuration. For additional stability, other tray configurations can include a locking mechanism to releasably connect the stand with the tray. Once the stand is placed on the lift base, the user can operate the lift device 564 as described above with reference to the first stand embodiment to place the wheels in contact with the support surface to roll the stand by itself or while supporting an object, such as a motorcycle, along the support surface. To place the lift base in the stationary configuration, the user operates the lift device to position the wheels relative to the support surface so that the weight of the stand (and any object supported thereon) are supported by the bottom side of the tray. It is to be appreciated that the lift base can also include stationary feet connected with the tray upon which the lift base can rest when in the stationary configuration.

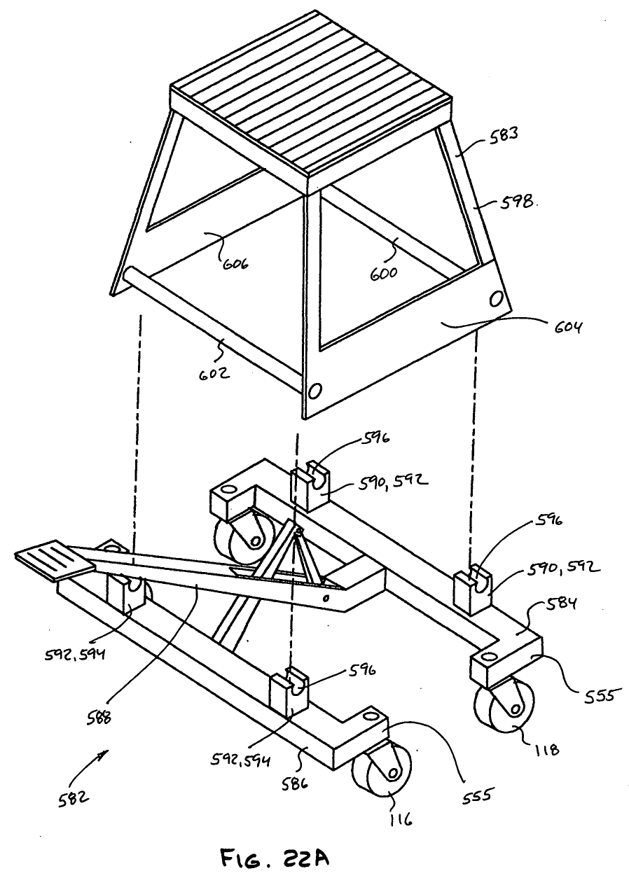

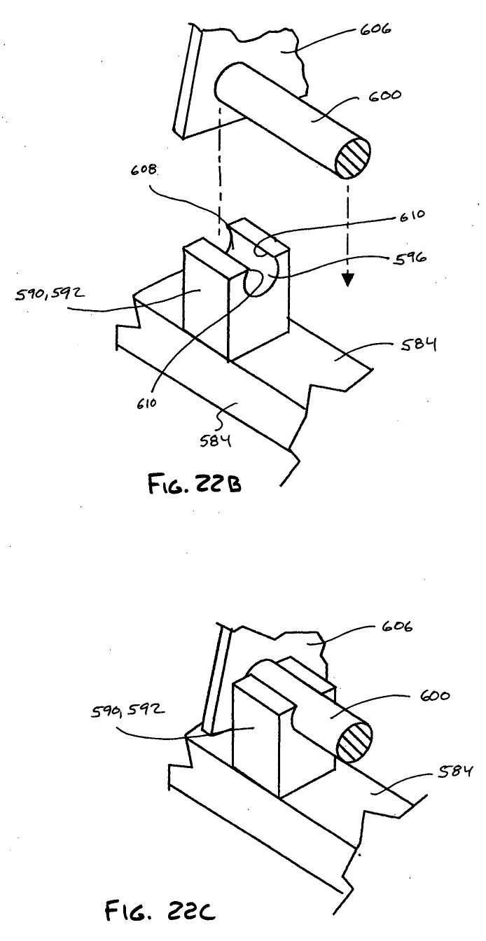

FIGS. 22A-22C show another embodiment of a lift base 582 adapted to support a stationary motorcycle stand 583. As shown in FIG. 22A, the base 555 includes first and second wheel support members 584, 586 coupled with a lift device 588. The lift device 588 includes first and second lift mechanisms 180, 182 and is substantially similar to the lift device described above with reference to first stand embodiment. As shown in FIG. 22A, a first pair 590 of pivot members 592 are connected with the first wheel support member 584, and a second pair 594 of pivot members 592 are connected with the second wheel support member 586. FIG. 20B shows a detailed view of a pivot member 592. A channel 596 located in the upper side of the pivot member 592 is adapted to receive a portion of the stationary motorcycle stand 583. More particularly, the motorcycle stand 582 shown in FIG. 20A includes a frame 598 having first and second base cross members 600, 602 connected with and separated by right and left sides 604, 606. FIGS. 20B and 20C show detailed views of the connection between the base cross member 600 with the pivot support 592 located on the left end portion of the first wheel support member 584, which is substantially representative of the structures for all four pivot members. As such, the channels 596 on the pivot members 592 are adapted to receive portions of the first and second base members 600, 602. As such, the stationary stand 583 is placed on the lift base by inserting the cross members 600, 602 into the channels in the pivot members.

In one embodiment of the lift base 582 shown in FIGS. 22A-22C, the pivot members 592 are made of a resilient material and the channels are configured with an open top 608 defined by opposing lips 610 extending inward toward each other. The width of the open top 608 can be slightly smaller than the diameters of the base cross members 600, 602 on the stand 583. As such, when inserting the cross members into the channels, opposing sides of the pivot members adjacent the longitudinal axis of the channel resiliently deflect outward away from each other as the cross member passes through the open top. As the cross member continues to be inserted into the channel, the resiliency of the pivot members causes the opposing sides to move inward toward each other, placing the lips over top portions of the cross members so as to “snap” the cross member into the channel and hold the cross members inside the channels. As such, the channels in the pivot members act as a connection mechanism to releasable connect the stand with the lift base. It is to be appreciated that other forms of connection structures can be used with the lift base to releasably connect the lift base with the pivot members, such straps, buckles, latches, and the like.

Once the cross members 600, 602 are inserted into channels 596, the user can manipulate the lift device 588 as described above to place the lift base in the stationary configuration and the mobile configuration. When placing the stand in the stationary and mobile configuration, the first and second wheel support members 584, 586 pivot about the first and second cross members, similar the first and second axles described above, to engage and disengage the wheels with the support surface. As shown in FIG. 19A, the cross members 600, 602 on the stationary stand are located above the bottoms of the right and left stand frame sides such that when the lift base is in the stationary configuration, the wheels are positioned relative to the support surface so that the weight of the stand (and any object supported thereon) is supported by the right and left sides of the stationary stand frame 598. It is to be appreciated that the stationary stand can also include stationary feet connected with the frame upon which the stationary stand can rest when the lift base is in the stationary configuration. When in the stationary configuration, the stationary stand rests directly on the support surface, and as such, utilization of the lift base does not increase the free standing height of the stationary stand. As described above, the user can also operate the lift device 588 to pivot the wheel support members 584, 586 and associated pivot members 592 around the cross members 600, 602 on the stationary stand frame to place the wheels in contact with the ground. When in the mobile configuration, the user can roll the stand by itself or while supporting a motorcycle along the support surface.

Although various representative embodiments of this invention have been described above with a certain degree of particularity, those skilled in the art could make numerous alterations to the disclosed embodiments without departing from the spirit or scope of the inventive subject matter set forth in the specification and claims. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A stand for supporting motorcycles and all-terrain vehicles above of a support surface, the stand comprising:
a frame including a base portion;
a first member coupled with the frame, the first member selectively movable between a first position and a second position;
a second member coupled with the frame;
a third member coupling the first member with the second member so that the second member correspondingly moves with the first member;
at least one first wheel coupled with the first member;
at least one second wheel coupled with the second member;
wherein when the first member is in the first position, the frame is rollingly supported by the at least one first wheel and the at least one second wheel; and
wherein when the first member is in the second position, the frame is supported by the base portion.

2. The stand of claim 1, wherein the at least one first wheel comprises two first wheels and the at least one second wheel comprises two second wheels.

3. The stand of claim 2, wherein the two first wheels comprise caster wheels.

4. The stand of claim 1, further comprising:
a first axle pivotally coupled with the frame;
a second axle pivotally coupled with the frame; and
wherein the first member is cooupled with the first axle and the second member is coupled with the second axle.

5. The stand of claim 4, wherein the at least one first wheel is connected with the first axle, and the at least one second wheel is connected with the second axle.

6. The stand of claim 4, wherein the third member is a Heim joint.

7. The stand of claim 4, wherein the third member comprises a roller rotatably connected with the first member and rollingly engaged with the second member.

8. The stand of claim 4, wherein the third member comprises a pin connected with the first member, and wherein the second member includes a slot adapted slidingly receive the pin.

9. The stand of claim 4, further comprising a locking member connected with the first member and operable to selectively couple the first member with the second axle to maintain the first member in the first position.

10. The stand of claim 9, wherein the locking member includes hooks.

11. The stand of claim 4, wherein the third member comprises a crank shaft rotatably connected with the frame.

12. The stand of claim 11, wherein the third member includes a first threaded portion and a second threaded portion;
wherein the first member is threadedly coupled with the first threaded portion;
wherein the second member is threadedly coupled with the second threaded portion.

13. The stand of claim 1, further comprising a handle connected with the first member.

14. The stand of claim 1, further comprising a spring connected with the first member adapted to maintain the first member in the second position.

15. The stand of claim 1, further comprising a locking member connected with the frame and coupled with the first member to selectively maintain the first member in the first position.

16. The stand of claim 15, wherein the locking member includes a slot, and wherein the first member extends through the slot.

17. The stand of claim 1, further comprising a top having a drain aperture connected with the frame.

18. A stand for supporting motorcycles and all-terrain vehicles above of a support surface, the stand comprising:
a frame including a base portion;
a first axle pivotally coupled with the frame;
a second axle pivotally coupled with the frame;
a first member connected with the first axle;
a second member connected with the second axle;
a third member coupling the first member with the second member;
at least one first wheel connected with the first axle;
at least one second wheel connected with the second axle;
wherein when the first member moves to a first position, the at least one first wheel and the at least one second wheel engage the support surface to rolling support the frame; and
wherein when the first member moves to a second position, the frame is supported by the base portion.

19. The stand of claim 18, wherein the at least one first wheel comprises two first wheels and the at least one second wheel comprises two second wheels.

20. The stand of claim 19, wherein the two first wheels comprise caster wheels.

21. The stand of claim 18, wherein the third member is a Heim joint.

22. The stand of claim 18, wherein the third member comprises a roller rotatably connected with the first member and rollingly engaged with the second member.

23. The stand of claim 18, wherein the third member comprises a pin connected with the first member, and wherein the second member includes a slot adapted slidingly receive the pin.

24. The stand of claim 18, further comprising a locking member connected with the first member and operable to selectively couple the first member with the second axle to maintain the first member in the first position.

25. The stand of claim 24, wherein the locking member includes hooks.

26. The stand of claim 18, wherein the third member comprises a crank shaft rotatably connected with the frame.

27. The stand of claim 26, wherein the third member includes a first threaded portion and a second threaded portion;
wherein the first member is threadedly coupled with the first threaded portion;
wherein the second member is threadedly coupled with the second threaded portion.

28. The stand of claim 18, further comprising a spring connected with the first member adapted to maintain the first member in the second position.

29. A stand for supporting motorcycles and all-terrain vehicles above of a support surface, the stand comprising:
a frame;
a first member coupled with the frame, the first member selectively movable between a first position and a second position;
at least one first wheel rotatably connected with the first member;
at least one second wheel rotatably connected with the frame; and
wherein when the first member is in the first position, the frame is rollingly supported by the at least one first wheel and the at least one second wheel; and
wherein when the first member is in the second position, the frame is supported by the at least one second wheel and the base portion.

30. The stand of claim 29, wherein the at least one first wheel comprises two first wheels and the at least one second wheel comprises two second wheels.

31. The stand of claim 30, wherein the two first wheels comprise caster wheels.

32. The stand of claim 29, further comprising a locking member connected with the frame and coupled with the first member to selectively maintain the first member in the first position.

33. The stand of claim 32, wherein the locking member includes a slot, and wherein the first member extends through the slot.

34. A stand for supporting motorcycles and all-terrain vehicles above of a support surface, the stand comprising:
a frame including a base portion;
a jack connected with the frame, the jack operable between an extended configuration and a retracted configuration;
at least two wheels connected with the jack;
wherein when the jack is in the extended configuration, the frame is rollingly supported by the at least two wheels; and
wherein jack the jack is in the retracted configuration, the frame is supported by the base portion.

35. The stand of claim 34, wherein the jack comprises a hydraulic jack.

36. A stand for supporting motorcycles and all-terrain vehicles above of a support surface, the stand comprising:
a frame;
at least two wheels connected with the jack;
a jack connected with the frame, the jack operable between an extended configuration and a retracted configuration;
wherein when the jack is in the retracted configuration, the frame is rollingly supported by the at least two wheels; and
wherein when the jack is in the extended configuration, the frame is supported by the jack.

37. A lift base for supporting motorcycles and all-terrain vehicles above of a support surface, the lift base comprising:
a base adapted to support a motorcycle and all-terrain vehicle stand;
a first member coupled with the base, the first member selectively movable between a first position and a second position;
a second member coupled with the base;
a third member coupling the first member with the second member so that the second member correspondingly moves with the first member;
at least one first wheel coupled with the first member;
at least one second wheel coupled with the second member; and
wherein when the first member is in the first position, the base is rollingly supported by the at least one first wheel and the at least one second wheel.

38. The stand of claim 37, wherein the at least one first wheel comprises two first wheels and the at least one second wheel comprises two second wheels.

39. The stand of claim 38, wherein the two first wheels comprise caster wheels.

40. The lift base of claim 37, wherein the base comprises a tray.

41. The lift base of claim 37, wherein the base comprises:
a first wheel support member connected with the first member and the at least one first wheel; and
a second wheel support member connected with the second member and the at least one second wheel.

42. The lift base of claim 41, the base further comprising:
a first pair of pivot members connected with the first wheel support member;
a second pair of pivot members connected with the second wheel support member; and
wherein each pivot members defines a open channel adapted to releaseably connect with a portion of a motorcycle stand.

43. A stand for supporting motorcycles and all-terrain vehicles comprising:
a frame including a base portion;
a plurality of wheels coupled with the frame; and
a lift means for moving at least one of the plurality of wheels, the lift means operable between a first position wherein the frame is rolling supported by the plurality of wheels and a second position wherein the frame is supported by the base portion.

44. The stand of claim 43, further comprising:
a locking means for selectively holding the lift means in the first position.

45. A stand for supporting motorcycles and all-terrain vehicles, the stand comprising:
a frame including a base portion;
a first member coupled with the frame, the first member selectively movable between a first position and a second position;
a second member coupled with the frame and with the first member;
at least one first wheel coupled with the first member;
at least one second wheel coupled with the second member;
wherein when the first member is in the first position, the frame is rollingly supported by the at least one first wheel and the at least one second wheel; and
wherein when the first member is in the second position, the frame is supported by the base portion.

46. The stand of claim 45, wherein the at least one first wheel comprises two first wheels and the at least one second wheel comprises two second wheels.

47. The stand of claim 46, wherein the two first wheels comprise caster wheels.

48. The stand of claim 45, further comprising a third member connected with the first member and the second member.

49. The stand of claim 48, wherein the third member is a Heim joint.

50. The stand of claim 48, wherein the third member comprises a roller rotatably connected with the first member and rollingly engaged with the second member.

51. The stand of claim 48, wherein the third member comprises a pin connected with the first member, and wherein the second member includes a slot adapted slidingly receive the pin.

52. The stand of claim 48, wherein the third member includes a first threaded portion and a second threaded portion;
wherein the first member is threadedly coupled with the first threaded portion;
wherein the second member is threadedly coupled with the second threaded portion.

53. The stand of claim 45, further comprising a spring connected with the first member adapted to maintain the first member in the second position.

54. The stand of claim 45, further comprising a locking member connected with the first member to selectively maintain the first member in the first position.
